(19) United States
(12) Patent Application Publication
(10) Pub. No.: US 2017/0134127 A1
(43) Pub. Date: May 11, 2017

(54) APPARATUS AND METHOD OF SIGNALING A STARTING OFDM SYMBOL FOR MTC UE

(71) Applicant: Spreadtrum Hong Kong Limited, Shanghai (CN)

(72) Inventor: Ari Juhani PELTOLA, Oulu (FI)

(73) Assignee: Spreadtrum Hong Kong Limited, Shanghai (CN)

(21) Appl. No.: 14/934,802

(22) Filed: Nov. 6, 2015

(51) Int. Cl. H04L 5/00; H04W 4/00

(52) U.S. Cl. CPC H04L 5/0048; H04L 5/0007; H04W 4/005

(57) ABSTRACT

Apparatuses and methods provide signaling start of Orthogonal Frequency Division Multiplexing (OFDM) symbols for MTC UE. An apparatus is provided for use in an OFDM wireless system, wherein the system supports transmissions of OFDM signals over a frequency band and includes a network component that communicates with the apparatus. The apparatus includes a receiver configured to receive signals in a narrowband within the frequency band, the narrowband having a narrower bandwidth than the frequency band, and a decoder configured to decode an indicator channel within the narrowband to determine a starting OFDM symbol for control and/or data information intended for the apparatus.

### BACKGROUND

I. Technical Field

The present disclosure relates to machine type communication devices and systems and in particular relates to apparatuses and methods of signaling a starting OFDM symbol intended for machine type communication devices.

II. Background

From Global System for Mobile Communications/General Packet Radio Service (GSM/GPRS) to Long Term Evolution (LTE), cellular networks have evolved to support higher data rates and wider coverage. At the same time, the evolution has brought about technical challenges, including, for example, support for high complexity as well as low complexity devices, and cost of overall network maintenance with a large number of radio access technologies (RATs) as evolved network deployments, for example LTE, may require.

Machine-Type Communications (MTC), a form of data communication that does not necessarily need human interaction, has been considered and developed to support low-cost and low-complexity devices such as a vending machine, a water meter, a gas meter, etc. Services optimized for machine type communications differ from services optimized for human-to-human communications. Distinctive MTC features may include low mobility, small data transmissions, infrequent termination originated by MTC User Equipment (UE), group-based policing, and group-based addressing.

MTC UE is user equipment supporting MTC capabilities. MTC UEs will be deployed in large numbers and may create an ecosystem on their own. MTC UEs for many applications require low operational power consumption and communicate with infrequent small burst transmissions. MTC UEs in extreme coverage scenarios might have characteristics such as low data rate, greater delay tolerance, and no mobility, and therefore some messages/channels may not be required. Some operators see MTC via cellular networks, easily served with existing RATs, as a significant opportunity for new revenues.

There is a substantial market for MTC UEs deployed inside buildings. For example, some MTC UEs are installed in the basements of residential buildings or locations shielded by foil-backed insulation, metalized windows, or traditional thick-walled building construction. But MTC UEs in such locations experience significantly greater penetration losses on the radio interface than normal LTE devices.

The 3^{rd} Generation Partnership Project (3GPP) has studied the challenge and concluded in 3GPP TR 36.888 that a target coverage improvement of 15-20 dB for both Frequency Division Duplexing (FDD) and Time Division Duplexing (TDD) in comparison to normal LTE footprint could support MTC devices deployed in challenging locations, e.g., deep inside buildings, and to compensate for gain loss caused by complexity reduction techniques. It was also concluded in 3GPP TR 36.888 that, in order to increase coverage of LTE system, data or control subframes may be repeated multiple times. For example, a number of repetition between 42 and 400 have been disclosed in section 9.5.6.1 for Physical Downlink Shared Channel (PDSCH) and a number of repetition between 100 and 200 for control subframes of Physical Downlink Control Channel (PDCCH) or Enhanced PDCCH (EPDCCH) has been suggested in section 9.5.4.

Unless specified otherwise, the term “MTC UE” is used herein to refer to an MTC UE supporting LTE Release 13 and onward, which may fall into several categories, including for example normal coverage (NC) terminals or enhanced coverage (CE) terminals. Control information and data may be carried on an MTC Physical Downlink Control Channel (MPDCCH) and a PDSCH, respectively. For NC terminals, MPDCCH control signal and associated PDSCH data are sent in one subframe without repetition. For CE terminals, they may be repeated over multiple subframes (e.g. over 2, 4, 8, 16, 64 or 128 subframes). An MTC UE operates only on narrowbands with, e.g., a 1.4 MHz bandwidth; namely, MPDCCH control information and associated PDSCH data are both transmitted within that narrowband. Thus, an MTC UE cannot receive control information on some existing physical control channels, including, for example, Physical Downlink Control Channel (PDCCH), Physical Control Format Indicator Channel (PCFICH), and Physical Hybrid-ARQ Indicator Channel (PHICH), which spread over the whole system bandwidth.

FIG. 5 illustrates an exemplary frame structure 500 in a current LTE system including downlink resource grid. Each radio frame 510 is T_{f}=307200*Tₛ=10 ms long and consists of 20 slots 520, numbered from 0 to 19, each of length Tₛₗₒₜ=15360·Tₛ=0.5 ms. A subframe 530 is defined as two consecutive slots 520 where subframe i consists of slots 2i and 2i+1.

As also shown in FIG. 5, resources for signal transmission in each slot are defined by a resource grid of N_{RB}^{DL} N_{SC}^{RB} subcarriers 540 and N_{symb}^{DL} OFDM symbols 550. The smallest unit in the resource grid, referred to as a resource element (RE) 570, corresponds to one subcarrier k and one OFDM symbol l and is uniquely identified by an index pair (k, l), where k=0, . . . , N_{RB}^{DL} N_{SC}^{RB}−1 and l=0, . . . , N_{symb}^{DL}−1. A resource block (RB) 560 comprises the resource elements across all N_{SC}^{RB} subcarriers and N_{symb}^{DL} OFDM symbols.

FIG. 6 shows an exemplary Physical Resource Block (PRB) pair 604 illustrating division of resource elements and OFDM symbols into control and data regions in a subframe. PRB pair is two consecutive PRBs in time domain and within a subframe. As exampled in FIG. 6, when dimension of one PRB is (12*7) resource elements in normal cyclic preface case, the size of a corresponding PRB pair becomes (12*14) resource elements. In PRB pair 604, the OFDM symbols in one subframe 603 are grouped into a control region 601 followed by a data region 602. In one example, control region 601 may have 1-3 OFDM symbols for system bandwidth larger than 10 resource blocks, 2-4 OFDM symbols for system bandwidths smaller or equal than 10 resource blocks and 1-2 OFDM symbols for Multicast Broadcast Single Frequency Network (MBSFN) or special subframes. Data region 602 starts from the next OFDM symbol right after control region 601 and may have 11 to 13 OFDM symbols. The OFDM symbols and resource elements in control region 601 may be used to transmit a plurality of control channels such as PDCCH 610, Cell-specific Reference Signal (CRS) 620, PCFICH 630, and PHICH 640. The resources 650 in data region 602 may be used to transmit data channels PDSCH, EPDCCH or MPDCCH.

FIG. 7 shows an exemplary frame structure with a narrowband for MTC UEs. Traditional control channels such as PDCCH, PCFICH and PHICH are transmitted in control region 601 and occupy the entire system bandwidth 710, e.g., 20 MHz. Data for UEs may be transmitted in data region 602 across the entire system bandwidth 710. An MTC UE, however, may operate only on a 1.4 MHz narrowband 720 within the system bandwidth 710, and cannot receive the traditional control channels across the entire system bandwidth 710. PDSCH 721-722 or control information on MPDCCH 723-726 may be transmitted in the data region 602_nb, part of data region 602, within narrowband 720.

If the number of OFDM symbols for existing physical control channels, such as PDCCH and PHICH, is fixed across all subframes, there could be up to a 15% loss of resources due to inefficiency. It is thus beneficial to allow the numbers of OFDM symbols for control and data to vary from subframe to subframe. Namely, the size of control region 601 may change on a subframe basis with traffic in a cell. For example, the number of OFDM symbols in control region 601 for a larger number of users may need to be greater than that for a smaller number of users. The number of OFDM symbols in control region 601 may be explicitly signaled on PCFICH 630 on the first OFDM symbol in control region 601. The signaling of the number of OFDM symbols in control region 601 also implicitly informs a starting position of OFDM symbols in data region 602.

When the number of OFDM symbols for control varies, an MTC UE needs to know the starting OFDM symbol for MPDCCH and PDSCH in the corresponding narrowband in order to decode control information on MPDCCH and/or data on PDSCH that immediately follow the existing physical control channels. Otherwise network either dissipates resources or the MTC UE malfunctions. Without such knowledge, the number of blind decodings within a subframe might be up to three times as high for an NC terminal as otherwise or three times the number of repetitions for CE terminal.

Because the MTC UE cannot decode PCFICH 630, which spreads over the entire system bandwidth, the starting MPDCCH OFDM symbol can be signaled by higher layers in subframes prior to MPDCCH subframes. A problem with that approach arises when repetition techniques are used, e.g., for CE terminals. Particularly, the network (e.g., eNodeB) changes the number of PDCCH OFDM symbols according to the number of UEs in a cell from subframe to subframe, but the MTC UE may assume the same starting OFDM symbol position signaled by the higher layers.

FIG. 9 illustrates an exemplary frame structure showing change of control region size during repetition. FIG. 9 shows that each subframe (e.g., 603a-603e, . . . , and 603x) comprises a control region 601 (e.g., 601a-601e, . . . , and 601x) and a data region 602 (e.g., 602a-602e, . . . , and 602x). In some embodiment, size of control region 601 may change on certain subframe during repetition of control signaling such as MPDCCH. As an example, there may be 3 OFDM symbols on control region, e.g., 601a-601c. The number of OFDM symbols may be changed into two on control region 601d and there are 2 OFDM symbols on control region, e.g., 601d-601e and 601x leaving unused resource elements, e.g., 910a-910c.

FIGS. 10A and 10B show 32 repetitions on a control channel, such as MPDCCH, over each of 32 subframes 1001-1032. FIG. 10A illustrates resource dissipation because of MTC UE's failure to adjust its data region size in response to a control region size change 1070. In this example, the higher layers signal to MTC UE at 1050 in subframe 1001 that 3 PDCCH symbols. Then, the network adjusts the number of PDCCH OFDM symbols from 3 to 1 at 1060 in subframe 1003. The MTC UE, however, fails to adjust in response to that change. This may result in unused resource elements 1075 over the subframes 1003-1032. During each of the 30 repetitions (i.e., 3^{rd}-32^{nd}), 2 OFDM symbols on narrowband are wasted, amounting to 17% of wasted resources.

FIG. 10B illustrates fault decoding of channels because of UE's failure to adjust its data region size. In this example, one PDCCH OFDM symbol on the first and second repetitions in subframes 1001 and 1002. The network adjusts a number of PDCCH OFDM symbols from 1 to 3 at 1080, but the MTC UE still assumes one PDCCH OFDM symbol. At 1090, UE tries erroneously to decode 2 extra PDCCH OFDM symbols as MPDCCH OFDM symbols, leading to a failure to decode the 32 subframes 1003-1032.

### SUMMARY

Consistent with embodiments of this disclosure, there is provided an apparatus for use in an OFDM wireless system, wherein the system supports transmissions of OFDM signals over a frequency band and includes a network component that communicates with the apparatus. The apparatus comprises a receiver configured to receive signals in a narrowband within the frequency band, the narrowband having a narrower bandwidth than the frequency band, and a decoder configured to decode an indicator channel within the narrowband to determine a starting OFDM symbol for control and/or data information intended for the apparatus.

Consistent with embodiments of this disclosure, there is also provided a method of determining a starting Orthogonal Frequency Division Multiplexing (OFDM) symbol following control channel OFDM symbols transmitted over a frequency band. The method comprises receiving signals in a narrowband within the frequency band, the narrowband having a narrower bandwidth than the frequency band, and decoding an indicator channel within the narrowband to determine a starting OFDM symbol for control and/or data information.

Consistent with embodiments of this disclosure, there is also provided a non-transitory computer readable storage medium that stores a set of instructions executable by a processor to cause an apparatus to determine a starting Orthogonal Frequency Division Multiplexing (OFDM) symbol following control channel OFDM symbols transmitted over a frequency band. The method comprises receiving signals in a narrowband within the frequency band, the narrowband having a narrower bandwidth than the frequency band, and decoding an indicator channel within the narrowband to determine a starting OFDM symbol for control and/or data information.

Consistent with embodiments of this disclosure, there is provided an apparatus of signaling a starting Orthogonal Frequency Division Multiplexing (OFDM) symbol. The apparatus comprises a processor configured to determine a change in a number of control channel OFDM symbols over a frequency band, and a transmitter configured to transmit an indicator channel over a narrowband within the frequency band to indicate a starting OFDM symbol, the narrowband having a narrower bandwidth than the frequency band.

Consistent with embodiments of this disclosure, there is also provided a method of signaling a starting Orthogonal Frequency Division Multiplexing (OFDM) symbol. The method comprises determining a change in a number of control channel OFDM symbols over a frequency band, and transmitting an indicator channel over a narrowband within a frequency band to indicate a starting OFDM symbol, the narrowband having a narrower bandwidth than the frequency band.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 shows an exemplary system architecture of wireless networks according to an illustrative embodiment of the present disclosure;

FIG. 2 illustrates an exemplary system providing uplink and downlink services according to an illustrative embodiment of the present disclosure;

FIG. 3 illustrates an exemplary system providing uplink and downlink services and its control and data channels according to an illustrative embodiment of the present disclosure;

FIG. 4 illustrates an exemplary block diagram of a system apparatus and/or a UE apparatus according to an illustrative embodiment of the present disclosure;

FIG. 5 illustrates an exemplary frame structure in a current LTE system including downlink resource grid;

FIG. 6 illustrates an exemplary PRB-pair showing division to control and data region over a subframe according to an illustrative embodiment of the present disclosure;

FIG. 7 illustrates an exemplary frame structure with a narrowband in a system bandwidth;

FIG. 8 illustrates an exemplary frame structure showing a narrowband in a system bandwidth according to an illustrative embodiment of the present disclosure;

FIG. 9 illustrates an exemplary frame structure showing change of control region size during repetition;

FIG. 10A illustrates resource dissipation under UE's failure to adjust its data region size;

FIG. 10B illustrates fault decoding of channels under UE's failure to adjust its data region size;

FIG. 11A illustrates an exemplary operation of network on narrowband transmitting a control channel when size of control region decreases according to an illustrative embodiment of the present disclosure;

FIG. 11B illustrates an exemplary operation of Normal Coverage (NC) or CE terminal with low repetition level on narrowband under the exemplary operation of network illustrated in FIG. 1 IA, according to an illustrative embodiment of the present disclosure;

FIG. 12A illustrates an exemplary operation of network on narrowband when size of control region increases according to an illustrative embodiment of the present disclosure;

FIG. 12B illustrates an exemplary operation of NC or CE terminal with low repetition level on narrowband under the exemplary operation of network illustrated in FIG. 12A, according to an illustrative embodiment of the present disclosure;

FIG. 13A illustrates an exemplary operation of network on narrowband when size of control region changes by 2 OFDM symbols according to an illustrative embodiment of the present disclosure;

FIG. 13B illustrates an exemplary operation of NC or CE terminal with low repetition level on narrowband under the exemplary operation of network illustrated in FIG. 13A, according to an illustrative embodiment of the present disclosure;

FIG. 14A illustrates another exemplary operation of network on narrowband when size of control region decreases according to an illustrative embodiment of the present disclosure;

FIG. 14B illustrates an exemplary operation of a CE terminal with high repetition level on narrowband under the exemplary operation of network illustrated in FIG. 14A, according to an illustrative embodiment of the present disclosure;

FIG. 15A illustrates another exemplary operation of network on narrowband when size of control region increases according to an illustrative embodiment of the present disclosure;

FIG. 15B illustrates an exemplary operation of CE terminal with high repetition level on narrowband under the exemplary operation of network illustrated in FIG. 15A, according to an illustrative embodiment of the present disclosure;

FIG. 16A illustrates another exemplary operation of network on narrowband when size of control region changes by 2 OFDM symbols according to an illustrative embodiment of the present disclosure;

FIG. 16B illustrates an exemplary operation of CE terminal with high repetition level on narrowband under the exemplary operation of network illustrated in FIG. 16A, according to an illustrative embodiment of the present disclosure;

FIG. 17A illustrates another exemplary operation of network on narrowband when size of control region increases in a same subframe according to an illustrative embodiment of the present disclosure;

FIG. 17B illustrates an exemplary operation of NC or CE terminal with low repetition level on narrowband under the exemplary operation of network illustrated in FIG. 17A, according to an illustrative embodiment of the present disclosure;

FIG. 18A illustrates another exemplary operation of network on narrowband transmitting MTC Physical Control Format Indicator Channel (MPCFICH) when size of control region increases according to an illustrative embodiment of the present disclosure;

FIG. 18B illustrates an exemplary operation of CE terminal with high repetition level on narrowband when size of control region increases under the exemplary operation of network illustrated in FIG. 18A, according to an illustrative embodiment of the present disclosure;

FIG. 19A illustrates an exemplary operation of network on narrowband transmitting a control channel at constant position when size of control region decreases according to an illustrative embodiment of the present disclosure;

FIG. 19B illustrates an exemplary operation of UE on narrowband under the exemplary operation of network illustrated in FIG. 19A, according to an illustrative embodiment of the present disclosure;

FIG. 20A illustrates another exemplary operation of network on narrowband transmitting a control channel at constant position when size of control region increases according to an illustrative embodiment of the present disclosure;

FIG. 20B illustrates another exemplary operation of UE on narrowband under the exemplary operation of network illustrated in FIG. 20B, according to an illustrative embodiment of the present disclosure;

FIG. 21 illustrates an exemplary method of decoding a control channel signal according to an illustrative embodiment of the present disclosure; and

FIG. 22 illustrates an exemplary method of providing a changed number of control channel OFDM symbols according to an illustrative embodiment of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Consistent with disclosure herein, there are provided apparatuses, systems, UEs, and methods that allow an MTC UE to work in an environment where the number of control channel OFDM symbols may change over subframes. Apparatuses may include a system, a base station, a NodeB, an eNodeB, and/or MTC UE.

Consistent with the present disclosure, a change in the number of control channel OFDM symbols used for transmitting traditional control channels across the whole system bandwidth, hereinafter referred to as the “traditional control channel OFDM symbols,” may be signaled to an MTC UE in the narrowband used by the MTC UE, so that the MTC UE may determine the starting OFDM symbol for MPDCCH and/or PDSCH and properly decode the same. In one embodiment, the change in the number of traditional control channel OFDM symbols may be signaled in an MTC Physical Control Format Indicator Channel (MPCFICH). The change may be expressly signaled in the MPCFICH or implicitly reflected in the presence or absence of the MPCFICH in a subframe. Embodiments consistent with the present disclosure increases resource utilization and decreases average number of repetitions of PDSCH and MPDCCH transmission for CE terminals. Embodiments described herein may apply to other communications or networks, systems and/or devices.

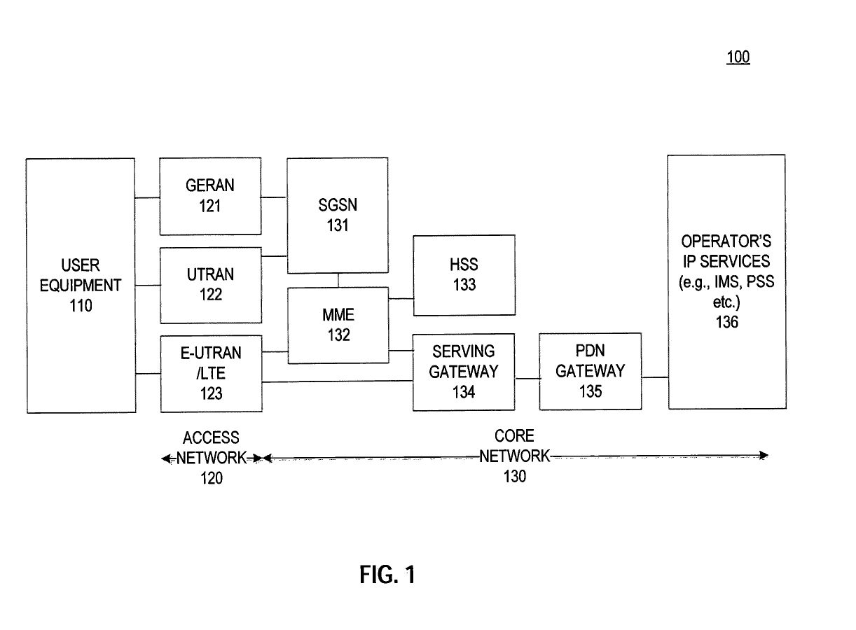

FIG. 1 shows an exemplary architecture of a wireless network system 100 according to an illustrative embodiment of the present disclosure. System 100 may comprise, for example, a plurality of UEs 110, an access network 120, and a core network 130.

UEs 110 are end-user devices, i.e., devices operated by end users, and may each be a terminal, a mobile device, a wireless device, a station, a client device, a laptop, a desktop, a tablet, etc. One or more of UEs 110 may be MTC UE. UE 110 may support one or more access technologies to communicate with GSM EDGE Radio Access Network (GERAN) 121, Universal Terrestrial Radio Access Network (UTRAN) 122, and/or Evolved-UTRAN (E-UTRAN)/LTE 123. UE 110 may transmit and receive control and data signals via one or more transceivers and provide various applications for a user such as Voice over Internet Protocol (VoIP) application, video steaming, instant messaging, web browsing, and so on.

Access network 120 may comprise GERAN 121, UTRAN 122, E-UTRAN/LTE 123 and provide one or more radio access technologies such as Code Division Multiple Access (CDMA), Wideband CDMA (WCDMA), WLAN, Worldwide Interoperability for Microwave Access (WiMAX). Core network 130 may comprise Serving GPRS Support Node (SGSN) 131, Mobility Management Entity (MME) 132, Home Subscriber Server (HSS) 133, SERVING GATEWAY 134, Packet Data Network (PDN) GATEWAY 135, and operator's Internet Protocol services 136 such as IP Multimedia Subsystem (IMS) and Packet Switched Streaming Service (PSS).

GERAN 121 may comprise a plurality of base transceiver stations and base station controllers. A base transceiver station is an initial access point that a UE 110 communicates for wireless service. A base transceiver station may transmit and receive radio signals via one or more transceivers on different frequencies and serve several sectors of a cell. A base transceiver station may also encrypt and decrypt communications. One base station controller may control or manage a plurality of base transceiver stations. A base station controller may allocate radio channels, receive measurement from UE 110, and control handover between different base transceiver stations.

UTRAN 122 may comprise a plurality of Node Bs and Radio Network Controllers (RNCs). A Node B in UTRAN 122 is equivalent to a base transceiver station in GERAN 121. A Node B may include one or more radio frequency transceivers used to directly communicate with a plurality of UEs 110. A Node B may serve one or more cells depending on configuration and type of antenna. An RNC may be responsible for controlling a plurality of Node Bs. An RNC may also perform radio resource management and mobility management functions. An RNC may further connect to a circuit switched core network through a media gateway and to SGSN 131 in packet switched core network.

E-UTRAN/LTE 123 may comprise a plurality of eNBs. Functionalities of an eNB may include radio resource management. An eNB may also schedule and transmit paging messages and broadcast information, and measure and report measurement configuration for mobility and scheduling. An eNB may further select an MME 132 at UE 110 attachment and route user plane data toward SERVING GATEWAY 134.

GERAN 121 and UTRAN 122 may communicate with SGSN 131 for data services. E-UTRAN/LTE 123 may communicate with MME 132 for data services. SGSN 131 and MME 132 may also communicate with each other, when necessary.

SGSN 131 may be responsible for delivery of data packets from/to UE 110 within its geographical service area. SGSN 131 may perform packet routing and transfer, mobility management, attach/detach and location management, logical link management and authentication and charging functions.

MME 132 is a key control node for E-UTRAN/LTE 123. MME 132 may be responsible for the paging and tagging procedure including retransmissions for UEs in idle mode. MME 132 may also be responsible for choosing SERVING GATEWAY 134 for a UE 110 at an initial attach and at time of intra-LTE handover involving core network node relocation. MME 132 may further be responsible for authenticating a user by interacting with HSS 133.

HSS 133 may be a database storing user and subscription information. HSS 133 may be responsible for mobility management, call and session establishment support, user authentication and access authorization.

SERVING GATEWAY 134 may be responsible for routing and forwarding user data packets, while also acting as a mobility anchor for a user plane during inter-eNB handovers and as an anchor for mobility between LTE and other 3GPP technologies. SERVING GATEWAY 134 may terminate downlink data path and trigger paging when downlink data arrives for a UE 110 in the idle mode. SERVING GATEWAY 134 may also manage and store UE contexts, e.g., parameters of IP bearer service, network internal routing information, replication of user traffic in case of lawful interception.

PDN GATEWAY 135 may, as a point of exit and entry of traffic, provide connectivity from a UE 110 to external packet data networks. A UE 110 may have simultaneous connectivity with more than one PDN GATEWAY 135 for accessing multiple PDNs. PDN GATEWAY 135 may perform policy enforcement, packet filtering for each user, sharing support, lawful interception, and packet screening. PDN GATEWAY 135 may further act as an anchor for mobility between 3GPP and non-3GPP technologies such as WiMAX, CDMA 1X, and (EVolution Data Optimized) EVDO.

The operator may provide specific IP services for certain applications. For example, the operator's IP services 136 may include, IP Multimedia Subsystem (IMS) and Packet Switched Streaming Service (PSS). IMS is an architectural framework for delivering IP multimedia services based on session-related protocols defined by Internet Engineering Task Force (IETF). IMS may aid access of multimedia and voice applications from wireless and wireline terminals, i.e., to create a form of fixed-mobile convergence. PSS may provide a streaming platform which supports a multitude of different applications including streaming of news at very low bitrates using still images and speech, music listening at various bitrates and qualities, video clips and watching live sports events. In addition to streaming, the platform supports also progressive downloading of media for selective media types.

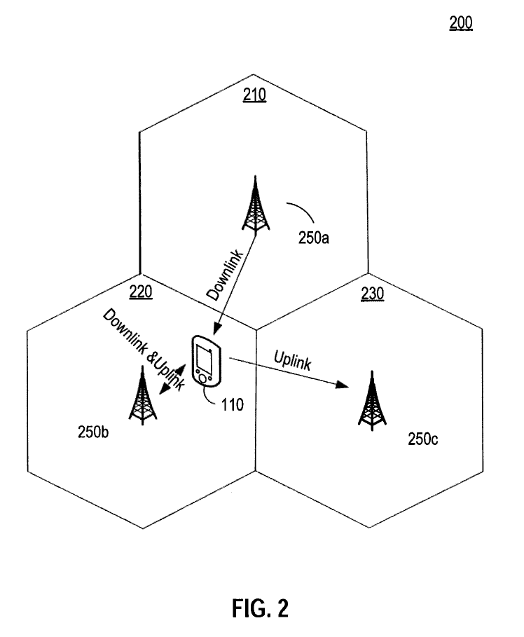

FIG. 2 illustrates an exemplary wireless system 200. System 200 includes a plurality of cells, e.g., 210, 220, and 230, managed by a plurality of base stations, e.g., 250a, 250b, 250c, respectively, in order to provide data services to UE 110 in a wireless or cellular network. Base station 250 (e.g., 250a-250c) is an initial access point to transmit and receive radio signals from/to UE 110. Base station 250 may be a base transceiver station in GERAN 121, a Node B in UTRAN 122, or an eNB in E-UTRAN/LTE 123. A base station 250 (e.g., 250a-250c) may control a plurality of cells, although FIG. 2 shows each base station controlling only one cell. Base station 250 and UE 110 transmit and receive a plurality of uplink and downlink control and data signals. In particular, UE 110 may receive downlink control or data signals from base stations 250a, 250b, or 250c, and generate and transmit uplink control or data signals to base station 250a, 250b, or 250c.

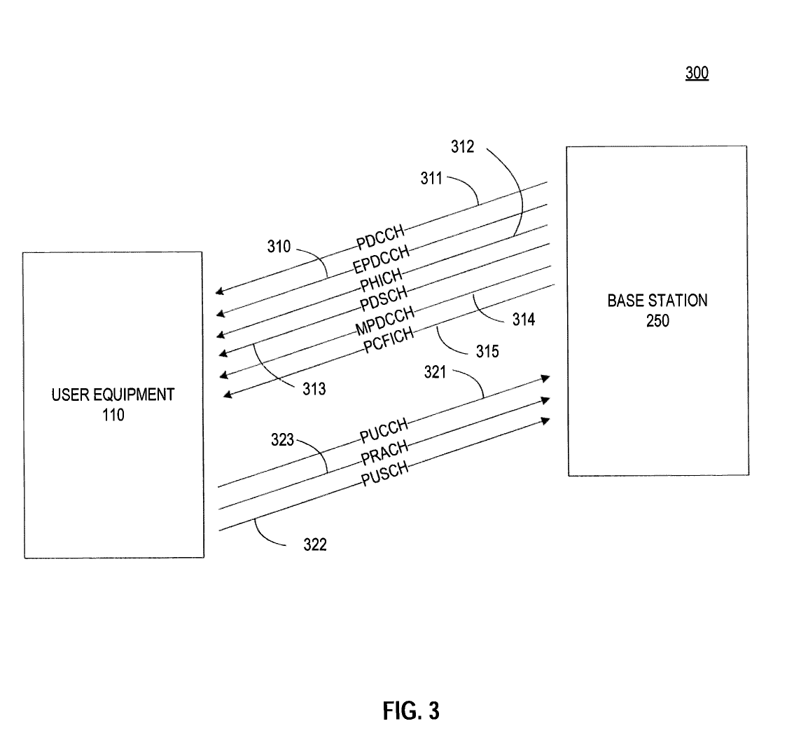

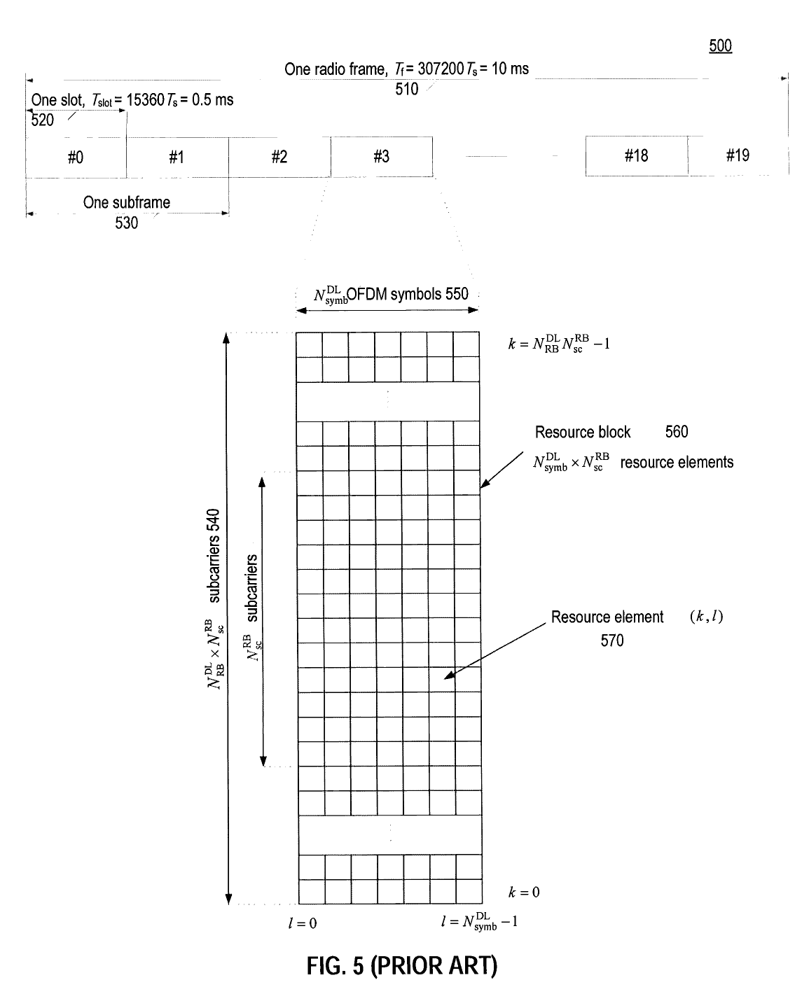

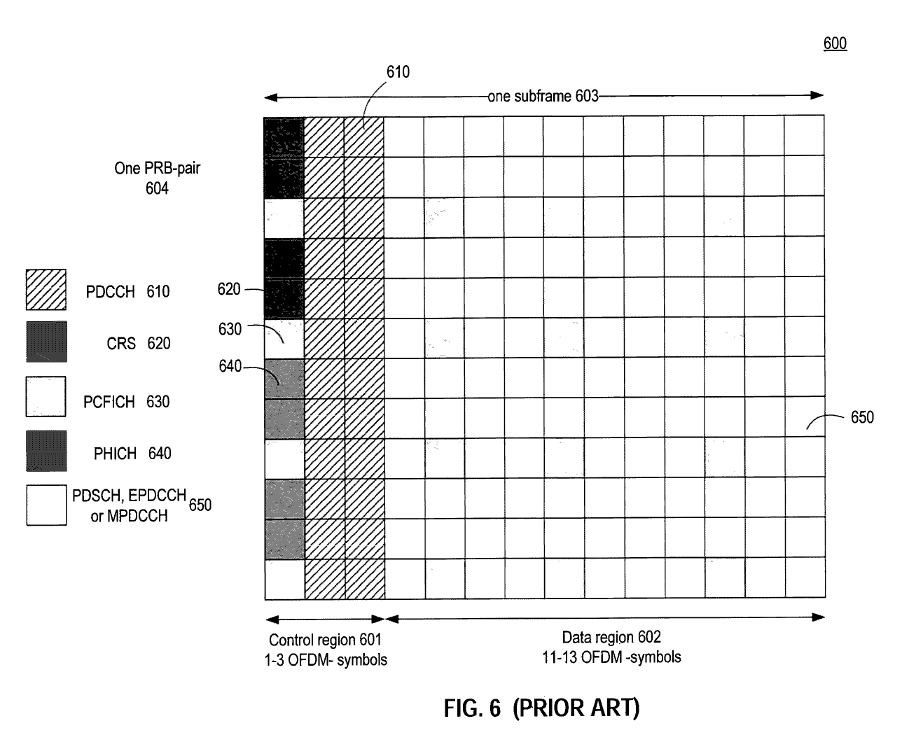

FIG. 3 illustrates an exemplary system 300 providing uplink and downlink control and data channels in the context of an LTE network. Uplink and downlink physical channels correspond to resource elements carrying information originating from higher layers and exchanged between a UE 110 and a base station 250 (e.g., 250a-250c). A resource element is defined as a frequency subcarrier over the time period of an OFDM symbol, as reflected in the grid illustration in FIG. 5. Uplink physical channels may include, for example, Physical Uplink Control Channel (PUCCH) 321, Physical Uplink Shared Channel (PUSCH) 322, and Physical Random Access Channel (PRACH) 323. Downlink physical channels may include, for example, EPDCCH 310, PDCCH 311, PHICH 312, PDSCH 313, MPDCCH 314, and PCFICH 315. System 300 may utilize other physical channels not shown in the figure.

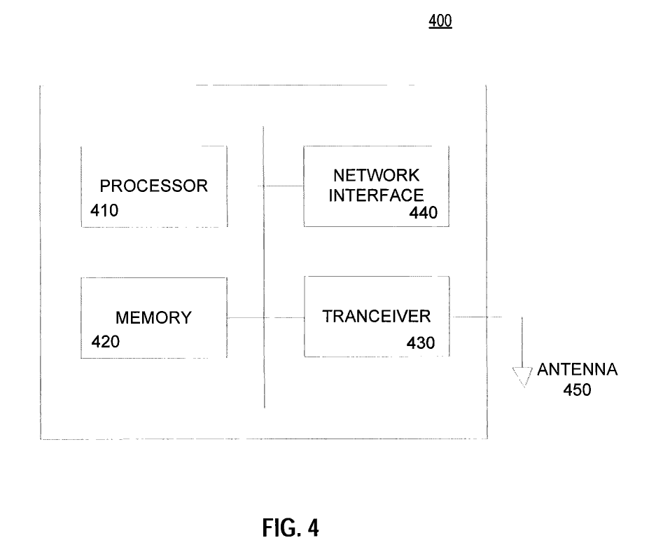

FIG. 4 illustrates an exemplary block diagram of a system apparatus and/or a UE apparatus. Apparatus 400 may be a base station, a Node B, an eNB, a UE, or an MTC UE. Apparatus 400 may include one or more processors 410, one or more memories 420, one or more transceivers 430, one or more network interfaces 440, and one or more antennas 450.

The one or more processors 410 may comprise a CPU (central processing unit) and may include a single core or multiple core processor system with parallel processing capability. The one or more processors 410 may use logical processors to simultaneously execute and control multiple processes. One of ordinary skill in the art would understand that other types of processor arrangements could be implemented that provide for the capabilities disclosed herein.

The one or more processors 410 execute some or all of the functionalities described above for either a UE 110 apparatus or a system (e.g., base station 250) apparatus. Alternative embodiments of the system apparatus may include additional components responsible for providing additional functionality, including any of the functionality identified above and/or any functionality necessary to support the embodiments described above.

The one or more memories 420 may include one or more storage devices configured to store information used by the one or more processors 410 to perform certain functions according to exemplary embodiments. The one or more memories 420 may include, for example, a hard drive, a flash drive, an optical drive, a random-access memory (RAM), a read-only memory (ROM), or any other computer-readable medium known in the art. The one or more memories 420 can store instructions to be executed by the one or more processors 410. The one or more memories 420 may be volatile or non-volatile, magnetic, semiconductor, optical, removable, non-removable, or other type of storage device or tangible computer-readable medium.

The one or more transceivers 430 are used to transmit signals to one or more radio channels, and receive signals transmitted through the one or more radio channels via one or more antennas 450.

The one or more network interfaces 440 may comprise wired links, such as an Ethernet cable or the like, and/or wireless links to one or more entities such as access nodes, different networks, or UEs. The one or more network interfaces 440 allow the one or more processors 410 to communicate with remote units via the networks.

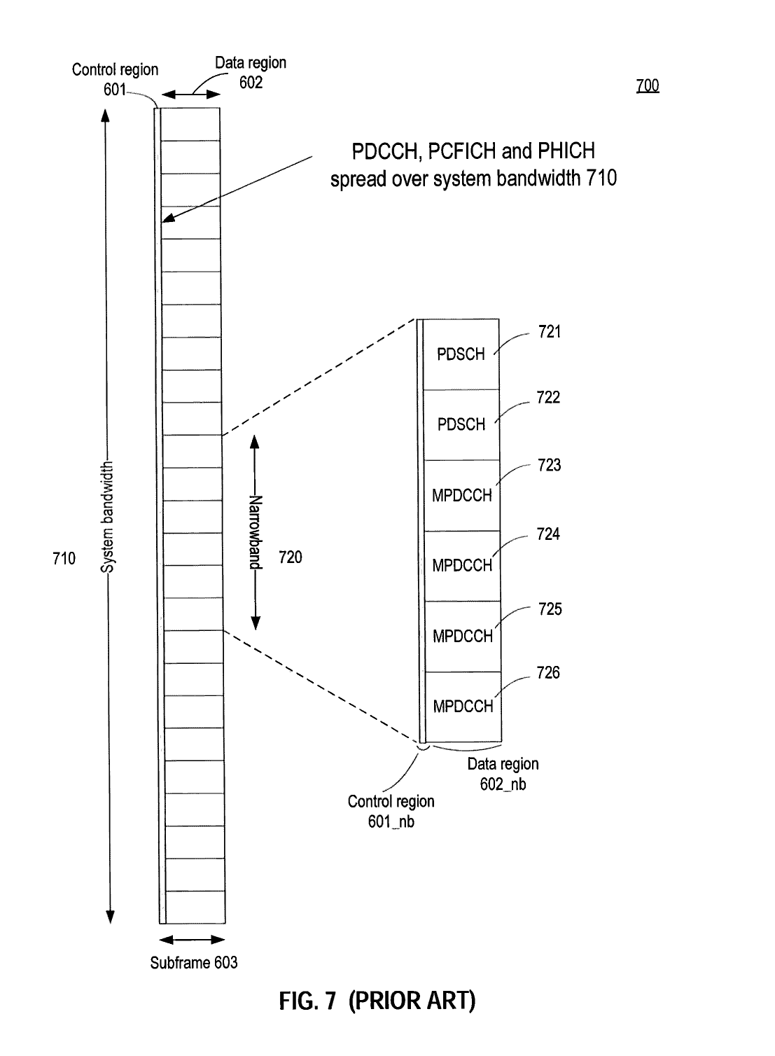

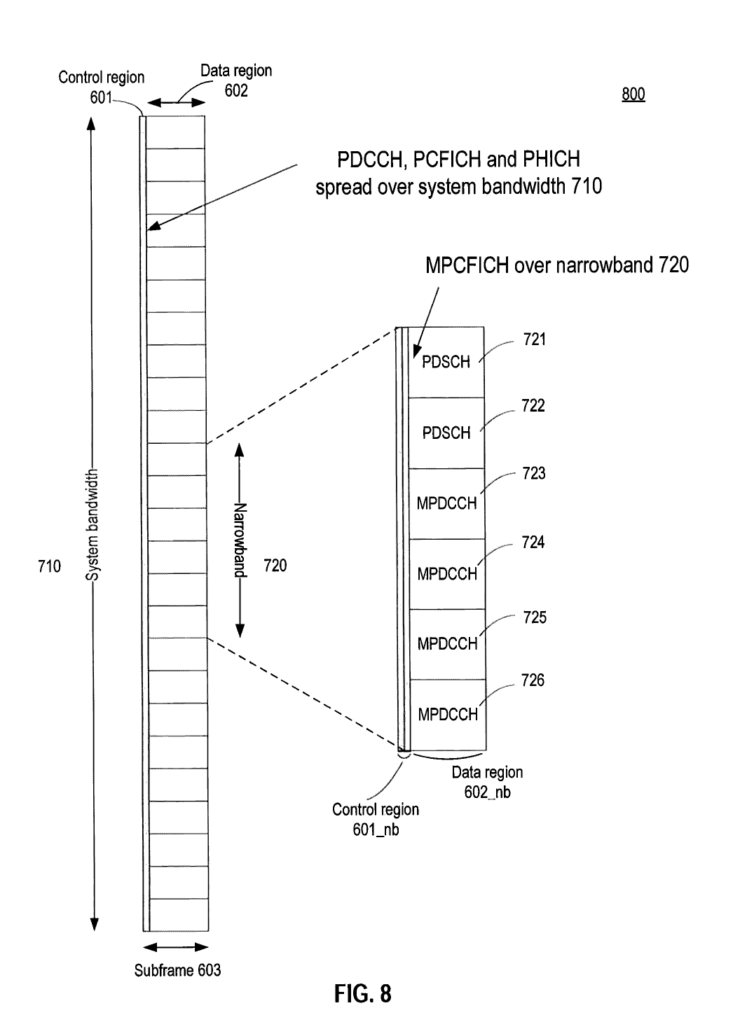

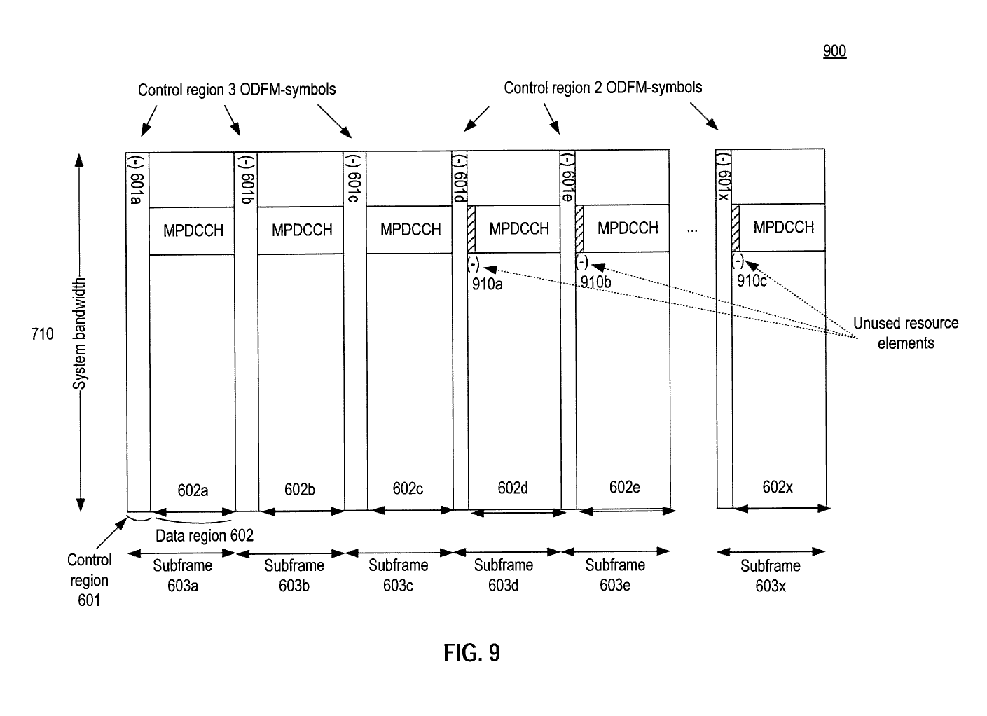

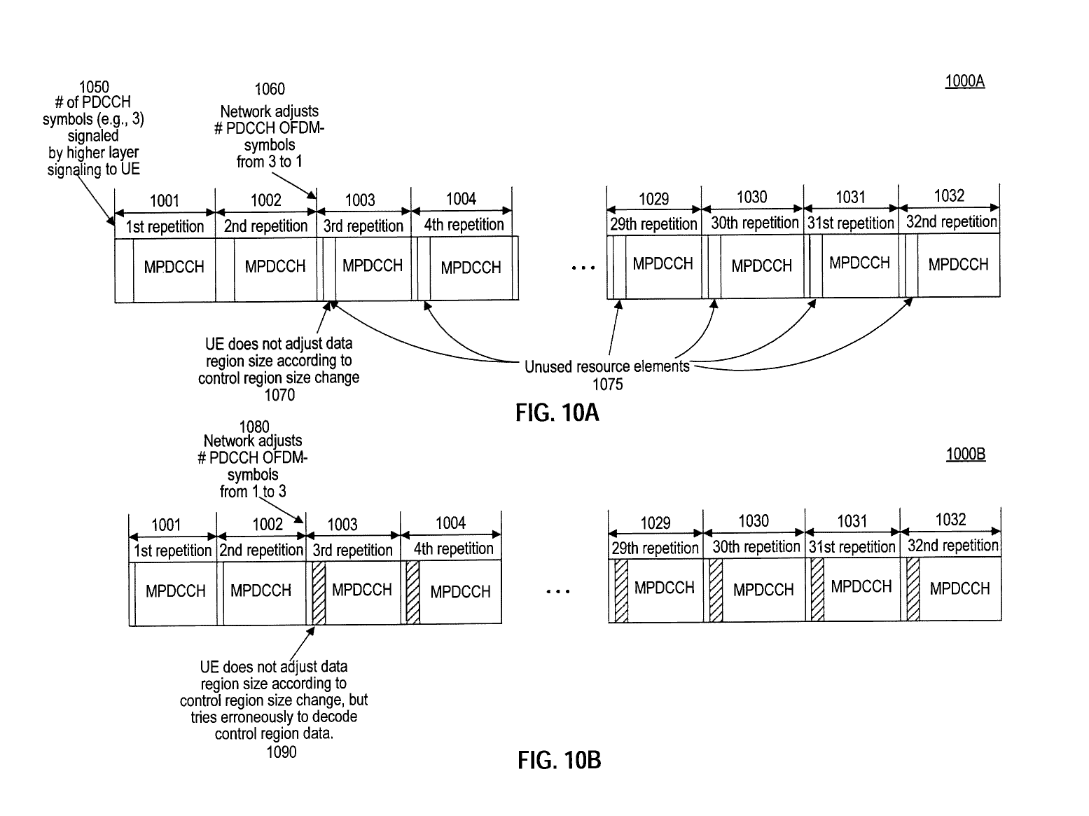

Consistent with embodiments of the present disclosure, there is provided an MPCFICH transmitted in the narrowband for an MTC UE to signal the start of OFDM symbols for MPDCCH or PDSCH information for the MTC UE. FIG. 8 shows an exemplary frame structure showing a narrowband in a system bandwidth according to an illustrative embodiment of the present disclosure. FIG. 8 shows the frame structure similar to the one shown in FIG. 7, except that the MPCFICH is now included in the transmission in the narrowband 720 for MTC UE.

As shown in FIG. 8, MTC UE is allowed to receive, within narrowband 720, PDSCH 721-722 or control information on MPDCCH 723-726, as well as MPCFICH, within data region 602_nb, which is part of data region 602. MPCFICH may be transmitted to indicate to the MTC UE the starting OFDM symbol for the corresponding data on PDSCH 721-722 or control information on MPDCCH 723-726. The MTC UE can decode MPCFICH and use the decoded information to receive and decode control signal on MPDCCH 723-726 or PDSCH 721-722. In one aspect, MPCFICH is transmitted only when control region size for PDCCH changes or is going to change. In another aspect, MPCFICH is transmitted in every subframe.

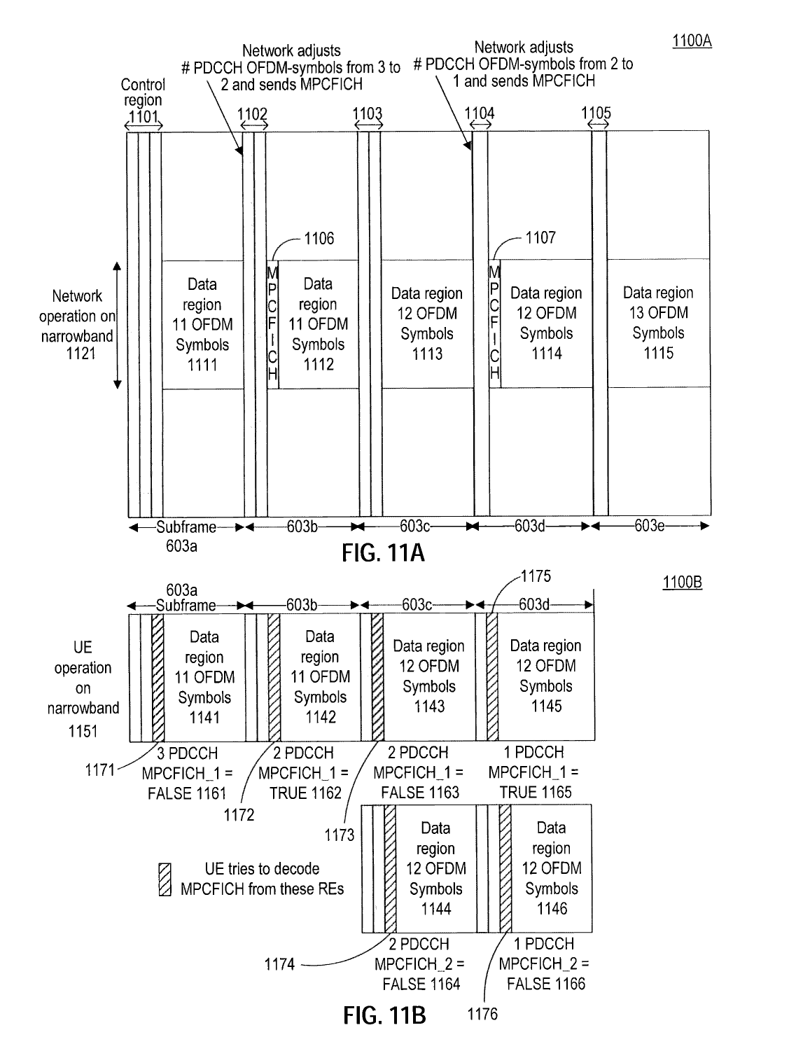

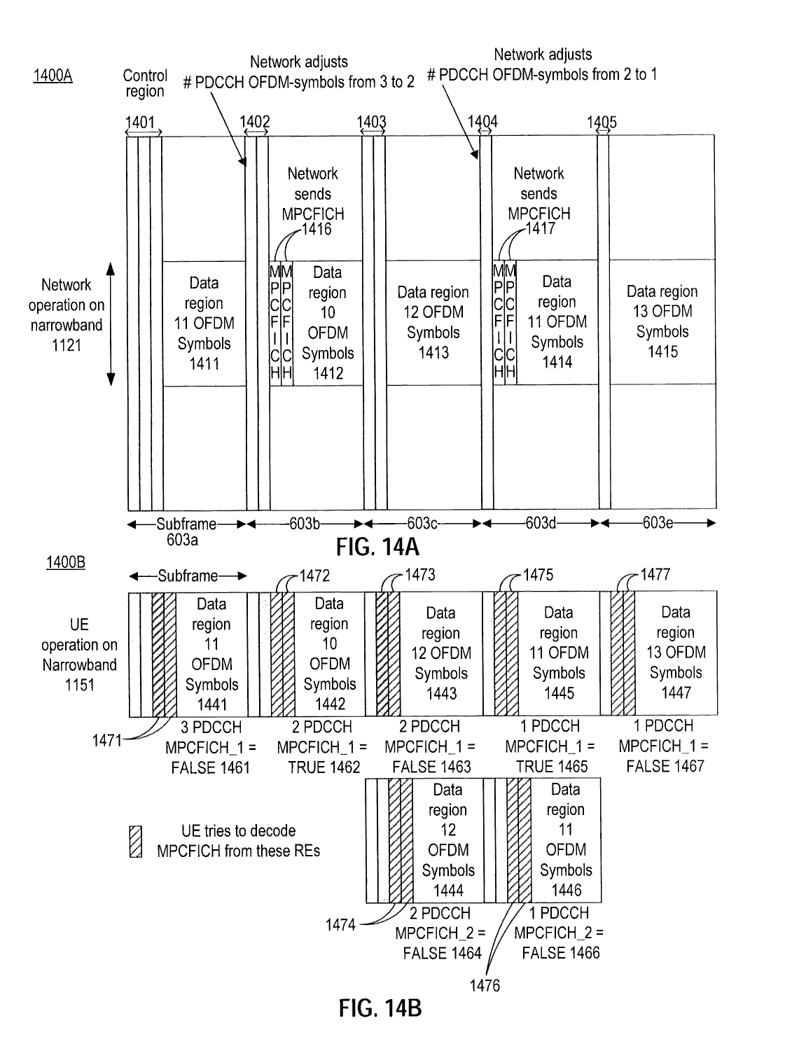

FIGS. 1 IA-20B illustrate various scenarios of signaling to an MTC UE, using the MPCFICH, the change in the number of control region OFDM symbols and the starting OFDM symbol for the MTC UE. FIGS. 11A-20A show network operation in a various scenarios of changing control region size and signaling the change to the MTC UE. FIGS. 11B-20B show corresponding MTC UE operations. FIGS. 11A-13B, 17A-17B, 19A-19B, and 20A-20B illustrate scenarios for NC terminals or for CE terminals with low numbers of repetitions, while FIGS. 14A-16B, and 18A-18B illustrate scenarios for CE terminals with large number of repetitions. In all these figures, the area in gray color (e.g., 1101-1105 in FIG. 1 IA) at the beginning of each subframe indicate control region for traditional or existing control channels, for example, PCFICH, PHICH and PDCCH. Data region or MPCFICH follow the control region. In FIGS. 11B-20B, cross-hatching (e.g., 1171-1176 in FIG. 11B) indicates where the MTC UE tries to decode MPCFICH. There are maximum 2 decoding attempts per subframe denoted MPCFICH_1 and MPCFICH_2. The MTC UE's decoding result may be TRUE or FALSE.

FIGS. 11A and 11B illustrate an exemplary operation of the network and MTC UE, respectively, on narrowband when the network transmits MPCFICH to signal a change in a number of PDCCH OFDM symbols in the subframe with the decreased number PDCCH OFDM symbols. FIG. 1I A shows that each subframe (e.g., 603a-603e) comprises a control region (e.g., 1101-1105) and a data region (e.g., 1111-1115). In this example, in a first subframe 603a, the size of the control region 1101 is 3 PDCCH OFDM symbols, and the size of data region 1111 is 11 OFDM symbols.

Assuming the number of PDCCH OFDM symbols is 3 in both subframe 603a and the subframe preceding 603a, the network does not send MPCFICH in subframe 603a because the number has not changed. Further assuming the maximum number of PDCCH OFDM symbols per subframe is 3, the number of PDCCH OFDM symbols could only have decreased from the preceding subframe to subframe 603a. Referring to FIG. 11B, the MTC UE therefore attempts to decode MPCFICH from the third OFDM symbol 1171, for the possibility of a decrease and MPCFICH being transmitted in that OFDM symbol. But because no MPCFICH was transmitted in the third symbol, the MTC UE fails to decode MPCFICH (MPCFICH_1=FALSE at 1161).

The network decreases the number of PDCCH OFDM symbols to 2 in subframe 603b and sends MPCFICH 1106 in the third OFDM symbol in the narrowband for the MTC UE. The size of data region 1112 remains 11 OFDM symbols. Referring to FIG. 11B, the MTC UE tries again to decode MPCFICH from the third OFDM symbol 1172 over subframe 603b and succeeds (MPCFICH_1=TRUE at 1162). From the decoded MPCFICH, the MTC UE learns the size of control region 1102 to be 2 OFDM symbols and the size of data region 1112/1142 to be 11 OFDM symbols in subframe 603b, because one OFDM symbol is used for MPCFICH. The MTC UE can now assume that the size of the data region will be 12 OFDM symbols in the next subframe 603c.

In the third subframe 603c, control region 1103 size does not change and the network does not send MPCFICH. The MTC UE tries to decode MPCFICH from the second OFDM symbol 1173, for the possible scenario that the control region size decreased to one OFDM symbol, and fails (MPCFICH_1=FALSE at 1163). The MTC UE also tries to decode MPCFICH from the third OFDM symbol 1174, for the possible scenario that the control region size increased to three OFDM symbols, and also fails (MPCFICH_2=FALSE at 1164). Thus, the control region size remains 2 OFDM symbols, and the data region size is 12 OFDM symbols.

In the fourth subframe 603d, the network decreases the number of OFDM symbols in control region 1104 from 2 to 1 and sends MPCFICH in second OFDM symbol 1107. The MTC UE tries to decode MPCFICH from the second OFDM symbol 1175, for the possible scenario that the control region size decreased to one OFDM symbol, and succeeds (MPCFICH_1=TRUE at 1165). Thus, the control region size is one OFDM symbol, and the data region size remains 12 OFDM symbols in subframe 603d, because one OFDM symbol was used to transmit MPCFICH. The MTC UE will assume that data region size increases to 13 OFDM symbols in the next subframe unless MPCFICH is detected. The MTC UE also tries to decode MPCFICH from the third OFDM symbol 1176, for the possible scenario that the control region size increased to three OFDM symbol, and fails (MPCFICH_2=FALSE at 1166).

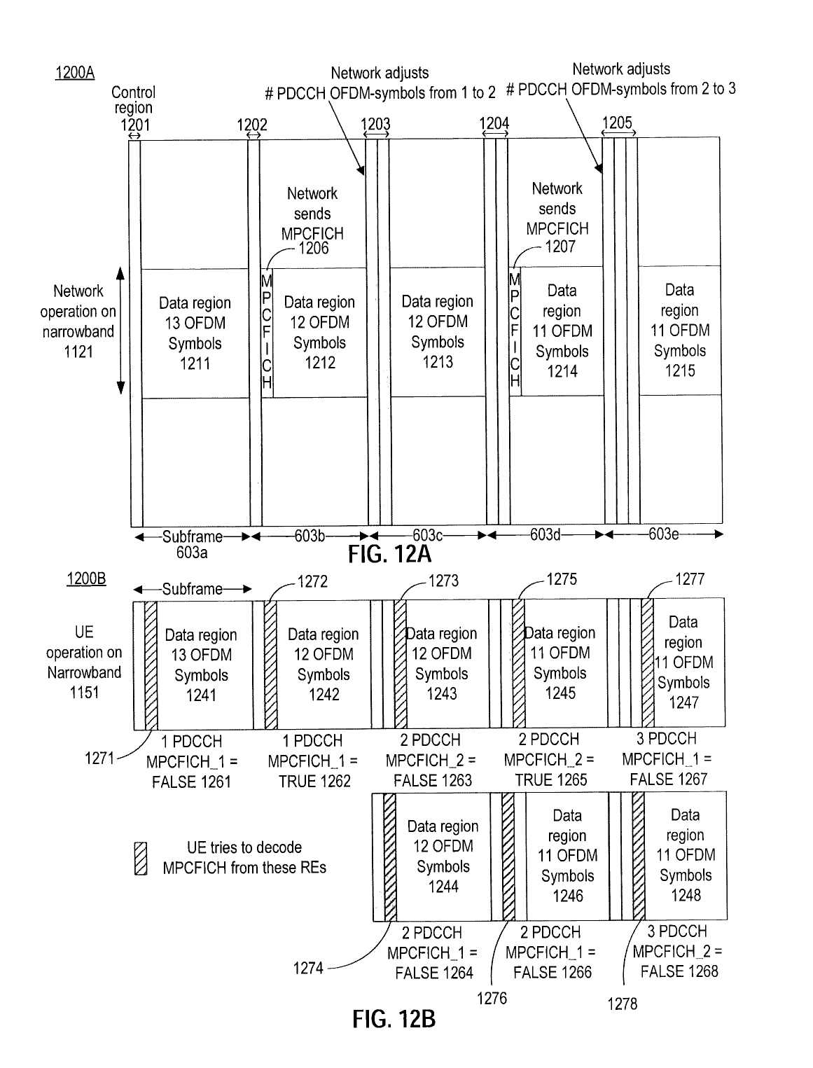

FIGS. 12A and 12B illustrate an exemplary operation of the network and MTC UE, respectively, on narrowband when the network transmits MPCFICH to signal a change in a number of PDCCH OFDM symbols in a subframe before the change occurs.

FIG. 12A shows that each subframe (e.g., 603a-603e) comprises a control region (e.g., 1201-1205) and a data region (e.g., 1211-1215). In this example, in a first subframe 603a, the size of data region 1211 is 13 OFDM symbols.

Assuming the number of PDCCH OFDM symbols is 1 in both subframe 603a and the subsequent subframe 603b, the network does not send MPCFICH in subframe 603a because the number will not change. Referring to FIG. 12B, the MTC UE attempts to decode MPCFICH from the second OFDM symbol 1271. But because no MPCFICH was transmitted in the second symbol, the MTC UE fails to decode MPCFICH (MPCFICH_1=FALSE at 1261). Thus, the MTC UE learns that the control region size will not change in the next subframe.

In subframe 603b, the control region size remains the same, i.e., one PDCCH OFDM symbol. The network sends MPCFICH 1206 in the second OFDM symbol in the narrowband for the MTC UE to indicate that the control region size will increase to 2 OFDM symbols in the next subframe. The size of data region 1212 decreases to 12 OFDM symbols because of the transmission of MPCFICH. Referring to FIG. 12B, the MTC UE tries again to decode MPCFICH from the second OFDM symbol 1272 in subframe 603b and succeeds (MPCFICH_1=TRUE at 1262). From the decoded MPCFICH, the MTC UE learns the size of control region will be 2 OFDM symbols in the next subframe 603c.

In the third subframe 603c, the network changes the number of OFDM symbols from 1 to 2, consistent with information sent during previous subframe. The network does not send a new MPCFICH because the control region size will not change in the next subframe 603d. The MTC UE tries to decode MPCFICH from the third OFDM symbol 1273, after the two PDCCH OFDM symbols, for the possibility that the control region size will change in subframe 603d, but fails (MPCFICH_2=FALSE at 1263). Thus, the data region size in subframe 603c remains 12 OFDM symbols 1243. In one aspect, the MTC UE also tries to decode MPCFICH from the second OFDM symbol 1274 because of the possibility of a false detection at 1272 in the previous subframe 603b but fails (MPCFICH_1=FALSE at 1264). In another aspect, the MTC UE assumes MPCFICH was decoded correctly at 1272 in the previous subframe 603b and does not attempt to decode MPCFICH in the third subframe 603c in OFDM symbols other than the third OFDM symbol at 1273.

In the fourth subframe 603d, the network sends MPCFICH 1207 in third symbol to indicate to the MTC UE that the number of OFDM symbols in control region will increase from 2 to 3 in the next subframe 603e. The MTC UE tries to decode MPCFICH from the third OFDM symbol 1275 and succeeds (MPCFICH_2=TRUE at 1265). UE learns that the control region size will increase in the next subframe. Data region size becomes 11 OFDM symbols 1245 in current subframe 603d because of the transmission of MPCFICH. In one aspect, the MTC UE also tries to decode MPCFICH from the second OFDM symbol, but fails (MPCFICH_1=FALSE at 1266). In another aspect, the MTC UE does not attempt to decode MPCFICH in the fourth subframe 603d in OFDM symbols other than the third OFDM symbol at 1275.

In the fifth subframe 603e, the network adjusts the number of OFDM symbols from 2 to 3 consistent with information sent during previous subframe. The network does not send MPCFICH. The MTC UE tries to decode MPCFICH from the fourth OFDM symbol 1277 but fails (MPCFICH_1=FALSE at 1267). The data region size remains unchanged having 11 OFDM symbols 1247. As before, the MTC UE may attempt to decode MPCFICH at the third OFDM symbol 1278 for the possibility of a false detection at 1275 in the previous subframe 603d, and also fails (MPCFICH_2=FALSE at 1268).

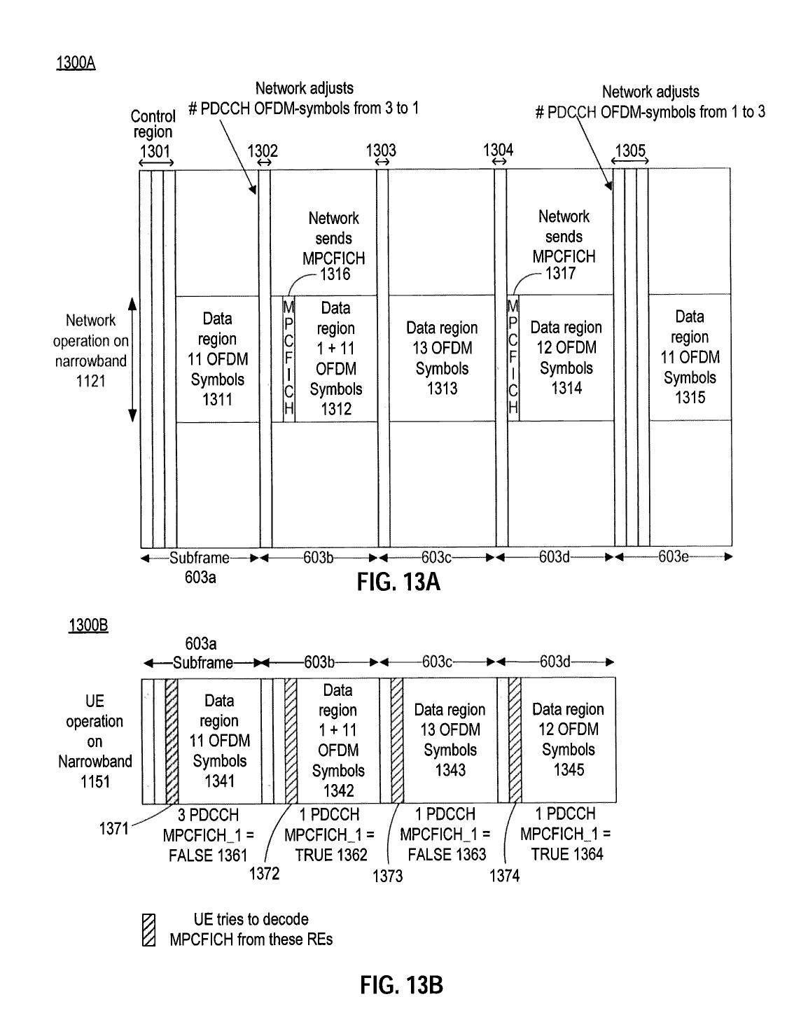

FIGS. 13A and 13B illustrate an exemplary operation of the network and MTC UE, respectively, on narrowband when the network transmits MPCFICH to signal a change in the control region size either in a current subframe or before the actual change occurs.

FIG. 13A shows that each subframe (e.g., 603a-603e) comprises a control region (e.g., 1301-1305) and a data region (e.g., 1311-1315). In this example, in a first subframe 603a, the size of data region 1311 is 1 OFDM symbols.

Assuming the number of PDCCH OFDM symbols is 3 in both subframe 603a and the subframe preceding 603a, the network does not send MPCFICH in subframe 603a because the number has not changed. Further assuming the maximum number of PDCCH OFDM symbols per subframe is 3, the number of PDCCH OFDM symbols could only have decreased from the preceding subframe to subframe 603a. Referring to FIG. 13B, the MTC UE therefore attempts to decode MPCFICH from the third OFDM symbol 1371, for the possibility of a decrease and MPCFICH being transmitted in that OFDM symbol. But because no MPCFICH was transmitted in the third symbol, the MTC UE fails to decode MPCFICH (MPCFICH_1=FALSE at 1361).

The network decreases the number of PDCCH OFDM symbols to 1 in subframe 603b and sends MPCFICH 1316 in the third OFDM symbol in the narrowband for the MTC UE to indicate that the control region size has changed from the previous subframe to the current subframe. The size of data region 1312 becomes 1+11 OFDM symbols. Referring to FIG. 13B, the MTC UE tries again to decode MPCFICH from the third OFDM symbol 1372 in subframe 603b and succeeds (MPCFICH_1=TRUE at 1362). From the decoded MPCFICH, the MTC UE learns the size of control region 1302 to be one OFDM symbol and the size of data region 1312/1342 to be 1+11 OFDM symbols in subframe 603b, because one OFDM symbol is used for MPCFICH. The MTC UE can now assume that the size of the data region will be 13 OFDM symbols in the next subframe 603c.

In the third subframe 603c, the control region size does not change and the network does not send MPCFICH. The number of OFDM symbols in control region can only increase from the previous subframe 603b. The MTC UE tries to decode MPCFICH from the second OFDM symbol 1373. This is the first OFDM symbol in data region in subframe 603c. In this example, the MTC UE fails to decode MPCFICH (MPCFICH_1==FALSE at 1363).

In the fourth subframe 603d, network sends MPCFICH 1317 in the second OFDM symbol to indicate that the number of OFDM symbols in control region will increase from 1 in the current subframe to 3 in the next subframe 603e. Data region size in the current subframe becomes 12 OFDM symbols 1314 because of the transmission of MPCFICH. The MTC UE tries to decode MPCFICH from the second OFDM symbol 1374 and succeeds (MPCFICH_1=TRUE at 1364). UE gets information that control region will increase during next subframe.

In the fifth subframe 603e, the network adjusts the number of OFDM symbols from 1 to 3 and does not send MPCFICH. Operation of the MTC UE in the fifth subframe 603e would be similar to that in the first subframe 603a and is therefore not illustrated.

FIGS. 14A and 14B illustrate an exemplary operation of the network and MTC UE, respectively, on narrowband when the network transmits MPCFICH over two OFDM symbols to signal a change in the control region size in a current subframe.

FIG. 14A shows that each subframe (e.g., 603a-603e) comprises a control region (e.g., 1401-1405) and a data region (e.g., 1411-1415). In this example, in a first subframe 603a, the size of the control region 1101 is 3 PDCCH OFDM symbols, and the size of data region 1411 is 11 OFDM symbols. The network operation in FIG. 14 A is similar to network operation in FIG. 11A, except that the network transmits MPCFICH over two consecutive OFDM symbols after control region. In one embodiment, UE has to be informed that it follows bigger repetitions in coverage enhancement in order to decode increased number of MPCFICH OFDM symbols.

Assuming the number of PDCCH OFDM symbols is 3 in both subframe 603a and the subframe preceding 603a, the network does not send MPCFICH in subframe 603a because the number has not changed. Further assuming the maximum number of PDCCH OFDM symbols per subframe is 3, the number of PDCCH OFDM symbols could only have decreased from the preceding subframe to subframe 603a. Referring to FIG. 14B, the MTC UE therefore attempts to decode MPCFICH from the third and fourth OFDM symbols 1471, for the possibility of a decrease and MPCFICH being transmitted in those OFDM symbols, and fails (MPCFICH_1=FALSE at 1461).

The network decreases the number of PDCCH OFDM symbols to 2 in subframe 603b and sends MPCFICH 1416 in the third and fourth OFDM symbols in the narrowband for the MTC UE. The size of data region 1412 becomes 10 OFDM symbols. Referring to FIG. 14B, the MTC UE tries again to decode MPCFICH from the third and fourth OFDM symbols 1472 over subframe 603b and succeeds (MPCFICH_1=TRUE at 1462). From the decoded MPCFICH, the MTC UE learns the size of control region 1402 to be 2 OFDM symbols and the size of data region 1412/1442 to be 10 OFDM symbols in subframe 603b, because two OFDM symbols are used for MPCFICH. The MTC UE can now assume that the size of the data region will be 12 OFDM symbols in the next subframe 603c.

In the third subframe 603c, control region 1403 size does not change and the network does not send MPCFICH. The MTC UE tries to decode MPCFICH from the second and third OFDM symbols 1473 for the possibility of a decrease in control region size to one OFDM symbol and fails (MPCFICH_1=FALSE at 1463). The number of OFDM symbols in control region can also increase to three. The MTC UE also tries to decode MPCFICH from the third and fourth OFDM symbols 1474 for the possibility of an increase in control region size to three OFDM symbols and again fails (MPCFICH_2=FALSE at 1464). Control region size in the current subframe is therefore 2, and data region size is 12 OFDM symbols 1443.

In the fourth subframe 603d, the network decreases the number of OFDM symbols in control region 1404 from 2 to 1 and sends MPCFICH in the second and third OFDM symbols 1417. The MTC UE tries to decode MPCFICH from the second and third OFDM symbols 1475 for the possibility of a decrease in control region size to one and succeeds (MPCFICH_1=TRUE at 1465). The MTC UE learns that the control region size is 1 and the data region size is 11 OFDM symbols 1445. The MTC UE can assume that data region has 13 OFDM symbols in next subframe if MPCFICH decoding fails then. The MTC UE may also try to decode MPCFICH from the third and fourth OFDM symbols 1476 for the possibility of an increase in control region size to 3 OFDM symbols, but fails (MPCFICH_2=FALSE at 1466).

In the fifth subframe 603e, the network does not send MPCFICH because the control region size does not change. The number of OFDM symbols in control region could only have increased from the previous subframe. The MTC UE therefore tries to decode MPCFICH from the second and third OFDM symbols 1477 for such possibility and fails (MPCFICH_1=FALSE at 1467). The data region size remains 13 OFDM symbols 1447.

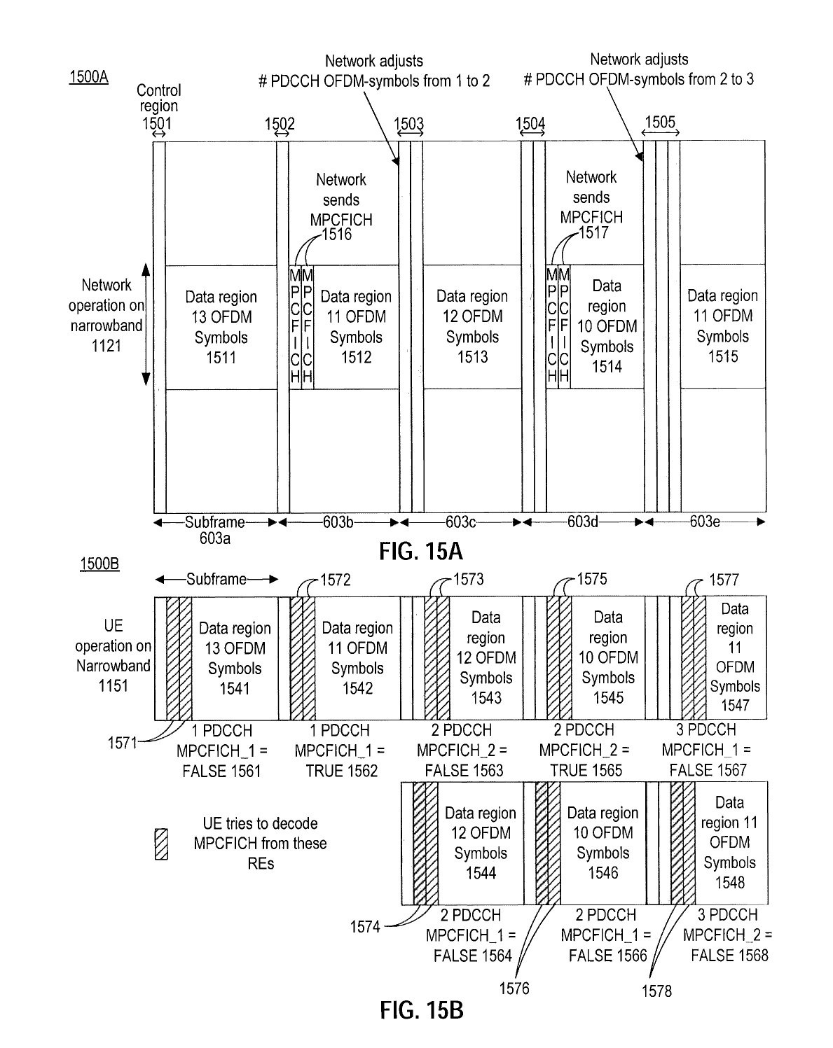

FIGS. 15A and 15B illustrate an exemplary operation of the network and MTC UE, respectively, on narrowband when the network transmits MPCFICH over two OFDM symbols to signal the change in control size in the subframe before the change occurs.

FIG. 15A shows that each subframe (e.g., 603a-603e) comprises a control region (e.g., 1501-1505) and a data region (e.g., 1511-1515). In this example, in a first subframe 603a, the size of data region 1511 is 13 OFDM symbols. Network operation in FIG. 15 A is similar to network operation in FIG. 12A, except that network transmits MPCFICH which is encoded to two consecutive OFDM symbols after control region. In one embodiment, the MTC UE has to be informed that it follows bigger repetitions in coverage enhancement in order to decode increased number of MPCFICH OFDM symbols.

Assuming the number of PDCCH OFDM symbols is 1 in both subframe 603a and the subsequent subframe 603b, the network does not send MPCFICH in subframe 603a because the number will not change. Referring to FIG. 15B, the MTC UE attempts to decode MPCFICH from the second and third OFDM symbols 1571. But because no MPCFICH was transmitted in the second and third symbols, the MTC UE fails to decode MPCFICH (MPCFICH_1=FALSE at 1561).

In subframe 603b, the network does not change the number of PDCCH OFDM symbols and sends MPCFICH over the second and third OFDM symbols 1516 to indicate that the control region size will increase to 2 OFDM symbols in the next subframe. The data region size becomes 11 OFDM symbols 1512 because of the use of the two OFDM symbols for the transmission of MPCFICH. Referring to FIG. 15B, the MTC UE tries to decode MPCFICH from the second and third OFDM symbols 1572. The MTC UE successfully decodes MPCFICH (MPCFICH_1=TRUE at 1562) and learns that the control region size will be 2 OFDM symbols in the next subframe.

In subframe 603c, the network increases the number of OFDM symbols for the control region to 2 and does not send MPCFICH. The size of data region 1513 is 12 OFDM symbols. Referring to FIG. 15B, the MTC UE tries to decode MPCFICH from the third and fourth OFDM symbols 1573 and fails (MPCFICH_2=FALSE at 1563). Thus, the MTC UE learns that the control region size will not change in the next subframe. In one aspect, the MTC UE also tries to decode MPCFICH from the second and third OFDM symbols 1574 because of the possibility of a false detection at 1572 in the previous subframe 603b and again fails (MPCFICH_1=FALSE at 1564). In another aspect, the MTC UE assumes MPCFICH was decoded correctly at 1572 and does not perform this additional step of decoding in subframe 603c.

In the fourth subframe 603d, the network sends MPCFICH in the third and fourth OFDM symbols 1517 to indicate the control size will change in the next subframe. The data region size is 10 OFDM symbols 1514 in subframe 603d because of the transmission of MPCFICH. The MTC UE tries to decode MPCFICH from the third and fourth OFDM symbols 1575 and succeeds (MPCFICH_2=TRUE at 1565). From the decoded MPCFICH, the MTC UE learns that the size of the control region will increase to 3 OFDM symbols in the next subframe 603d. In one aspect, the MTC UE also tries to decode MPCFICH from the second and third OFDM symbols 1576 but fails (MPCFICH_1=FALSE at 1566).

In subframe 603e, the network increases the number of PDCCH OFDM symbols to 3 consistent with information sent in the previous subframe and does not send MPCFICH. The size of data region 1515 is 11 OFDM symbols. Referring to FIG. 15B, the MTC UE tries to decode MPCFICH from the fourth and fifth OFDM symbols 1577 and fails (MPCFICH_1=FALSE at 1567). In one aspect, the MTC UE also tries to decode MPCFICH from the third and fourth OFDM symbols 1578 and again fails (MPCFICH_2=FALSE at 1568).

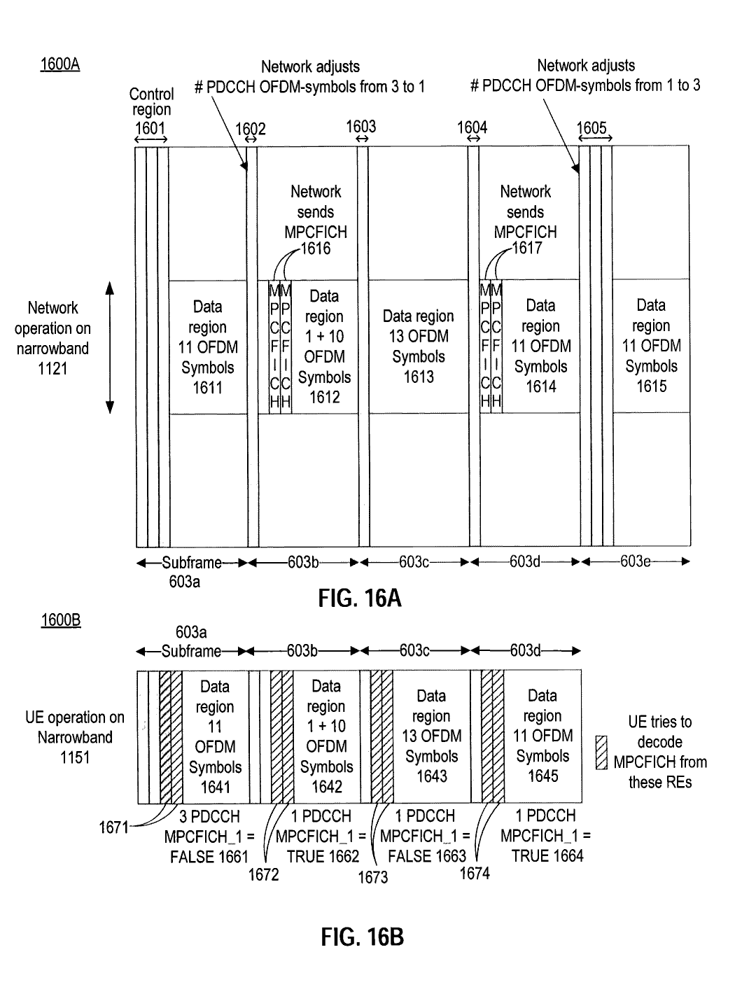

FIGS. 16A and 16B illustrate an exemplary operation of the network and MTC UE, respectively, on narrowband when the network transmits MPCFICH over two consecutive OFDM symbols to signal the change in the control size either in a current subframe or before the actual change occurs.

FIG. 16A shows that each subframe (e.g., 603a-603e) comprises a control region (e.g., 1601-1605) and a data region (e.g., 1611-1615). In this example, in a first subframe 603a, the size of the control region 1601 is 3 PDCCH OFDM symbols, and the size of data region 1611 is 11 OFDM symbols.

Assuming the number of PDCCH OFDM symbols is 3 in both subframe 603a and the subframe preceding 603a, the network does not send MPCFICH in subframe 603a because the number has not changed. Further assuming the maximum number of PDCCH OFDM symbols per subframe is 3, the number of PDCCH OFDM symbols could only have decreased from the preceding subframe to subframe 603a. Referring to FIG. 16B, the MTC UE therefore attempts to decode MPCFICH from the third and fourth OFDM symbols 1671, in the event of a decrease and MPCFICH being transmitted in those OFDM symbols. But because no MPCFICH was transmitted in the third and fourth symbols, the MTC UE fails to decode MPCFICH (MPCFICH_1=FALSE at 1661). The size of data region 1641 is thus 11 OFDM symbols.

The network decreases the number of PDCCH OFDM symbols to 1 in subframe 603b and sends MPCFICH 1616 in the third and fourth OFDM symbols in the narrowband for the MTC UE. The size of data region 1612 is 1+10 OFDM symbols. Referring to FIG. 16B, the MTC UE tries again to decode MPCFICH from the third and fourth OFDM symbol 1672 and succeeds (MPCFICH_1=TRUE at 1662). From the decoded MPCFICH, the MTC UE learns the size of control region 1602 to be one OFDM symbol and the size of data region 1612/1642 to be 1+10 OFDM symbols in subframe 603b, because two OFDM symbols are used for MPCFICH. The MTC UE can now assume that the size of the data region will be 13 OFDM symbols in the next subframe 603c.

In the third subframe 603c, network does not send MPCFICH, because the size of control region does not change. The number of OFDM symbols in control region can only increase from the previous subframe. The MTC UE tries to decode MPCFICH from the second and third OFDM symbols 1673, as they are the first and second OFDM symbols in data region in subframe 603c. In this example, UE fails to decode MPCFICH (MPCFICH_1=FALSE at 1663).

In the fourth subframe 603d, the network does not change the size of control region but sends MPCFICH 1617 in second and third OFDM symbols to indicate that the control region size will change to 3 OFDM symbols in the next subframe 603e. The data regions size in the current subframe becomes 11 OFDM symbols because of the transmission of MPCFICH. The MTC UE tries to decode MPCFICH from the second and third OFDM symbols 1674 and succeeds (MPCFICH_1=TRUE at 1664). From the decoded MPCFICH, the MTC UE learns that the size of the control region will increase in the next subframe.

In the fifth subframe 603e, the network increases the number of OFDM symbols to 3 and does not send MPCFICH. Operation of the MTC UE in the fifth subframe 603e would be similar to that in the first subframe 603a and is therefore not illustrated.

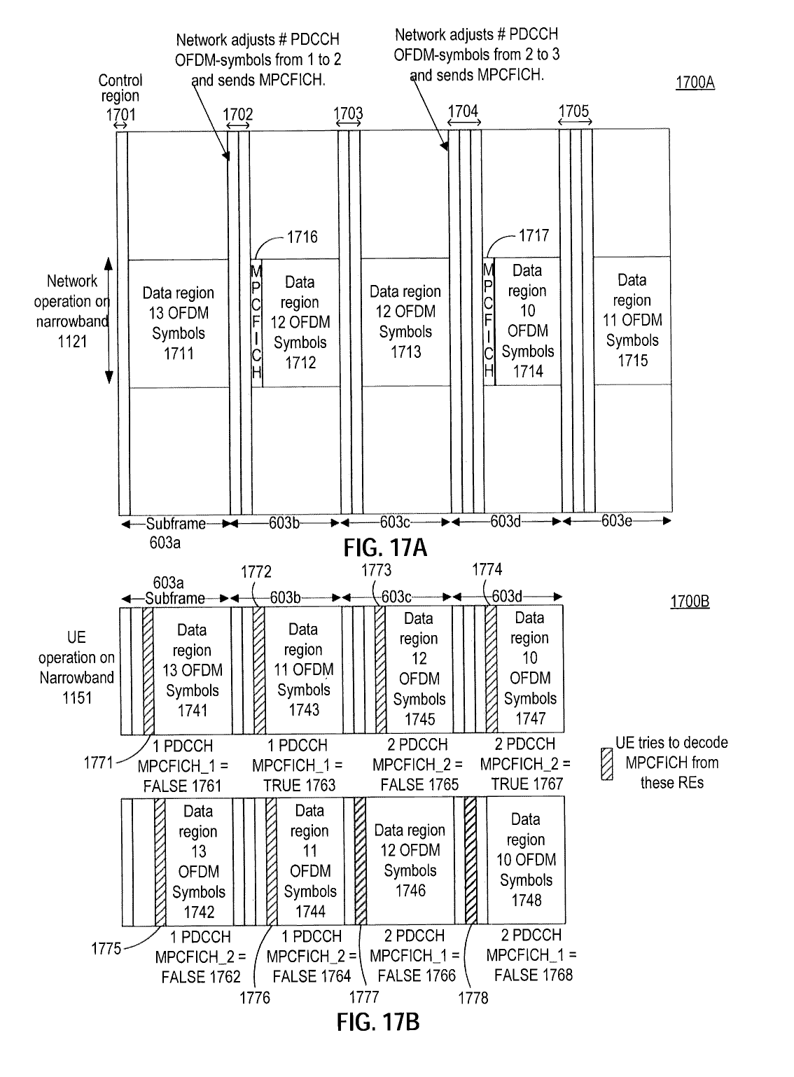

FIGS. 17A and 17B illustrate an exemplary operation of the network and MTC UE, respectively, on narrowband when the network increases a number of PDCCH OFDM symbols and signals the change in MPCFICH. In this embodiment, the network may increase the number of OFDM symbols by one or two symbols between subframes.

FIG. 17A shows that each subframe (e.g., 603a-603e) comprises a control region (e.g., 1701-1705) and a data region (e.g., 1711-1715). In this example, in a first subframe 603a, the size of the control region 1701 is 1 PDCCH OFDM symbol, and the size of data region 1711 is 13 OFDM symbols.

Assuming the number of PDCCH OFDM symbols is 1 in both subframe 603a and the subframe preceding 603a, the network does not send MPCFICH in subframe 603a because the number has not changed. Further assuming the minimum number of PDCCH OFDM symbols per subframe is 1, the number of PDCCH OFDM symbols could only have increased from the preceding subframe to subframe 603a. Referring to FIG. 17B, the MTC UE therefore attempts to decode MPCFICH from third OFDM symbol 1771, for the possibility of an increase in the control region size by one OFDM symbol and MPCFICH being transmitted in the third OFDM symbol, and fails (MPCFICH_1=FALSE at 1761). The MTC UE also tries to decode MPCFICH from the fourth OFDM symbol 1775, for the possibility of an increase in the control region size by two OFDM symbols and MPCFICH being transmitted in the fourth OFDM symbol, and again fails (MPCFICH_2=FALSE at 1762). Thus, the MTC UE learns that the control region size has not changed and remains one OFDM symbol in the current subframe 603a.

In the second subframe 603b, the network increases the number of PDCCH OFDM symbols for the control region to 2 and sends MPCFICH 1716 in the third OFDM symbol in the narrowband for the MTC UE. The size of data region 1712 becomes 11 OFDM symbols. Referring to FIG. 17B, the MTC UE tries to decode MPCFICH from the third OFDM symbol 1772 for the possibility of an increase in the control region size by one OFDM symbol and succeeds (MPCFICH_1=TRUE at 1763). The MTC UE also attempt to decode MPCFICH from the fourth OFDM symbol 1776 for the possibility of an increase in the control region size by two OFDM symbols and but fails (MPCFICH_2=FALSE at 1764). From the decoded MPCFICH, the MTC UE learns the size of control region 1702 to be 2 OFDM symbols and the size of data region 1743/1744 to be 11 OFDM symbols in subframe 603b, because one OFDM symbol is used for MPCFICH.

In the third subframe 603c, the network does not send MPCFICH because the network does not change the size of control region 1703. From the previous subframe, the number of OFDM symbols in the control region could only increase or decrease by 1. The MTC UE thus tries to decode MPCFICH from the fourth OFDM symbol 1773, for the possibility of an increase in the control region size and MPCFICH being transmitted in that OFDM symbol, but fails (MPCFICH_2=FALSE at 1765). The MTC UE also attempts to decode MPCFICH from the second OFDM symbol 1777, for the possibility of a decrease in the control region size and MPCFICH being transmitted in that OFDM symbol, and again fails (MPCFICH_1=FALSE at 1766). Thus, the MTC UE learns that the size of the control region has not changed in the current subframe.

The network increases the number of PDCCH OFDM symbols to 3 in subframe 603d and sends MPCFICH 1717 in the fourth OFDM symbol in the narrowband for the MTC UE. The size of data region 1714 becomes 10 OFDM symbols. Referring to FIG. 17B, the MTC UE tries to decode MPCFICH from the fourth OFDM symbol 1747 over subframe 603d in the event of an increase in the number of PDCCH OFDM symbols and succeeds (MPCFICH_2=TRUE at 1767). The MTC UE may also try to decode MPCFICH from second OFDM symbol, in the event of a decrease in the number of PDCCH OFDM symbols and MPCFICH being transmitted in that OFDM symbol. But because no MPCFICH was transmitted in the second symbol, the MTC UE fails to decode MPCFICH (MPCFICH_1=FALSE at 1768). From the decoded MPCFICH, the MTC UE learns the size of control region 1704 to be 3 OFDM symbols and the size of data region 1714/1747/1748 to be 10 OFDM symbols, because one OFDM symbol is used for MPCFICH.

In the fifth subframe 603e, the network does not send MPCFICH in subframe 603e because the number of PDCCH has not changed. The size of data region 1715 is 11 OFDM symbols.

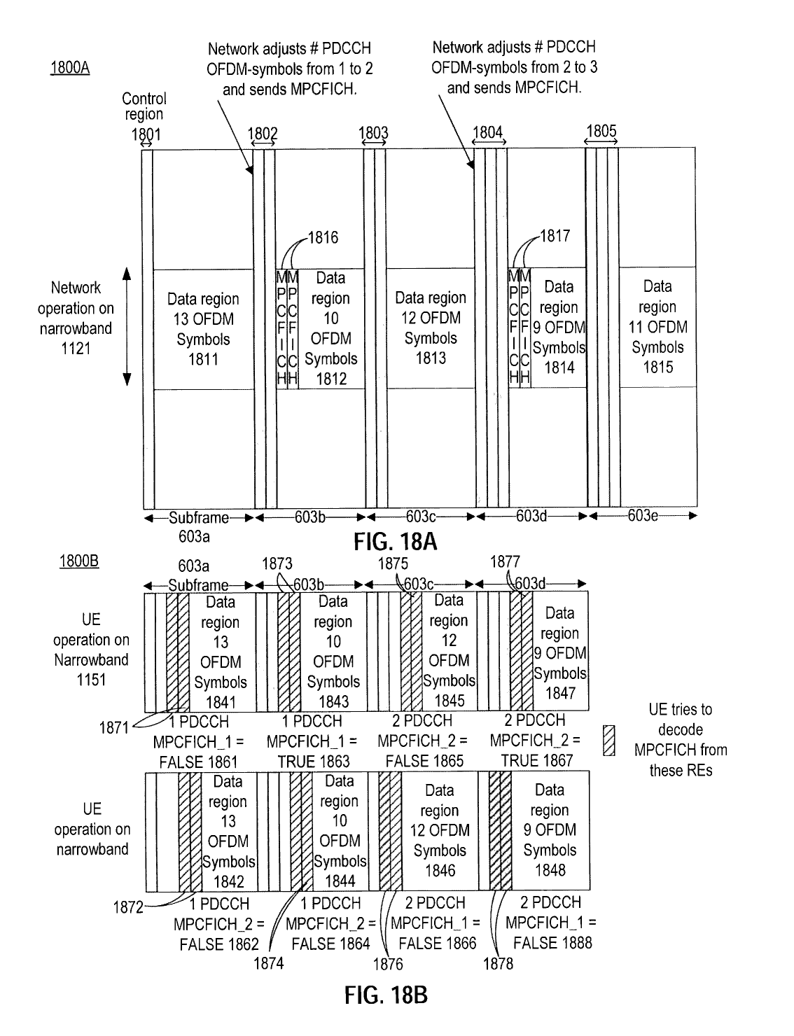

FIGS. 18A and 18B illustrate an exemplary operation of the network and MTC UE, respectively, on narrowband when the network increases a number of PDCCH OFDM symbols and signals the change in MPCFICH. In this embodiment, the size of the control region may change by 1 or 2 PDCCH OFDM symbols. The network and MTC UE operation in FIGS. 18A and 18B is similar to that in FIGS. 17A and 17B, except that network transmits MPCFICH on two consecutive OFDM symbols after control region in FIG. 18A and the MTC UE tries to decode MPCFICH on two consecutive OFDM symbols in FIG. 18B.

FIG. 18A shows that each subframe (e.g., 603a-603e) comprises a control region (e.g., 1801-1805) and a data region (e.g., 1811-1815). In this example, in a first subframe 603a, the size of data region 1811 is 13 OFDM symbols.

Assuming the number of PDCCH OFDM symbols is 1 in both subframe 603a and the subframe preceding 603a, the network does not send MPCFICH in subframe 603a because the number has not changed. Further assuming the minimum number of PDCCH OFDM symbols per subframe is 1, the number of PDCCH OFDM symbols could only have increased from the preceding subframe to subframe 603a. Referring to FIG. 18B, the MTC UE therefore attempts to decode MPCFICH from the third and fourth OFDM symbols 1871, in the event of an increase in the control region size by one OFDM symbol and MPCFICH being transmitted in the third and fourth OFDM symbols. But because no MPCFICH was transmitted in the third and fourth symbols, the MTC UE fails to decode MPCFICH (MPCFICH_1=FALSE at 1861). The MTC UE also attempts to decode MPCFICH from the fourth and fifth OFDM symbols 1872, in the event of an increase in the control region size by two OFDM symbols and MPCFICH being transmitted in the fourth and fifth OFDM symbols. But because no MPCFICH was transmitted in the fourth and fifth symbols, the MTC UE fails to decode MPCFICH (MPCFICH_2=FALSE at 1862). Thus, the MTC UE learns that the control size region has not changed from the previous subframe and remains 1 OFDM symbol in the current subframe.

In subframe 603b, the network increases the number of PDCCH OFDM symbols to 2 and sends MPCFICH 1816 in the third and fourth OFDM symbols in the narrowband for the MTC UE. The size of data region 1812 becomes 10 OFDM symbols. Referring to FIG. 18B, the MTC UE tries to decode MPCFICH from the third and fourth OFDM symbols 1873 and succeeds (MPCFICH_1=TRUE at 1863). The MTC UE again attempts to decode MPCFICH from the fourth and fifth OFDM symbols 1874 for the possibility of an increase in the control region size by 2 OFDM symbols but fails (MPCFICH_2=FALSE at 1864). From the decoded MPCFICH, the MTC UE learns the size of control region 1802 to be 2 OFDM symbols and the size of data region 1812/1843 to be 10 OFDM symbols in subframe 603b, because two OFDM symbols are used for MPCFICH.

In the third subframe 603c, the network does not send MPCFICH because the network does not change the size of control region 1803. The MTC UE tries to decode MPCFICH from fourth and fifth OFDM symbols 1875, for the possibility of an increase in the control region size and MPCFICH being transmitted in those OFDM symbols. But because no MPCFICH was transmitted in the fourth and fifth symbols, the MTC UE fails to decode MPCFICH (MPCFICH_2=FALSE at 1865). The MTC UE also attempts to decode MPCFICH from the second and third OFDM symbols 1876, for the possibility of a decrease in the control region size and MPCFICH being transmitted in the second and third OFDM symbols. But because no MPCFICH was transmitted in those OFDM symbols, the MTC UE fails to decode MPCFICH (MPCFICH_1=FALSE at 1866).

In subframe 603d, the network increases the number of PDCCH OFDM symbols to 3 and sends MPCFICH 1817 in the fourth and fifth OFDM symbols in the narrowband for the MTC UE. The size of data region 1814 becomes 9 OFDM symbols. Referring to FIG. 18B, the MTC UE tries to decode MPCFICH from the fourth and fifth OFDM symbols 1847 and succeeds (MPCFICH_2=TRUE at 1867). The MTC UE also tries to decode MPCFICH from the second and third OFDM symbols 1878, in the event of MPCFICH being transmitted in the second and third OFDM symbols. But because no MPCFICH was transmitted in those OFDM symbols, the MTC UE fails to decode MPCFICH (MPCFICH_1=FALSE at 1888). From the decoded MPCFICH, the MTC UE learns the size of control region 1804 to be 3 OFDM symbols and the size of data region 1814/1847 to be 9 OFDM symbols in subframe 603d, because two OFDM symbols are used for MPCFICH.

In the fifth subframe 603e, the network does not send MPCFICH in subframe 603e because the number of PDCCH OFDM symbols in the control region has not changed. The size of data region 1815 becomes 11 OFDM symbols.

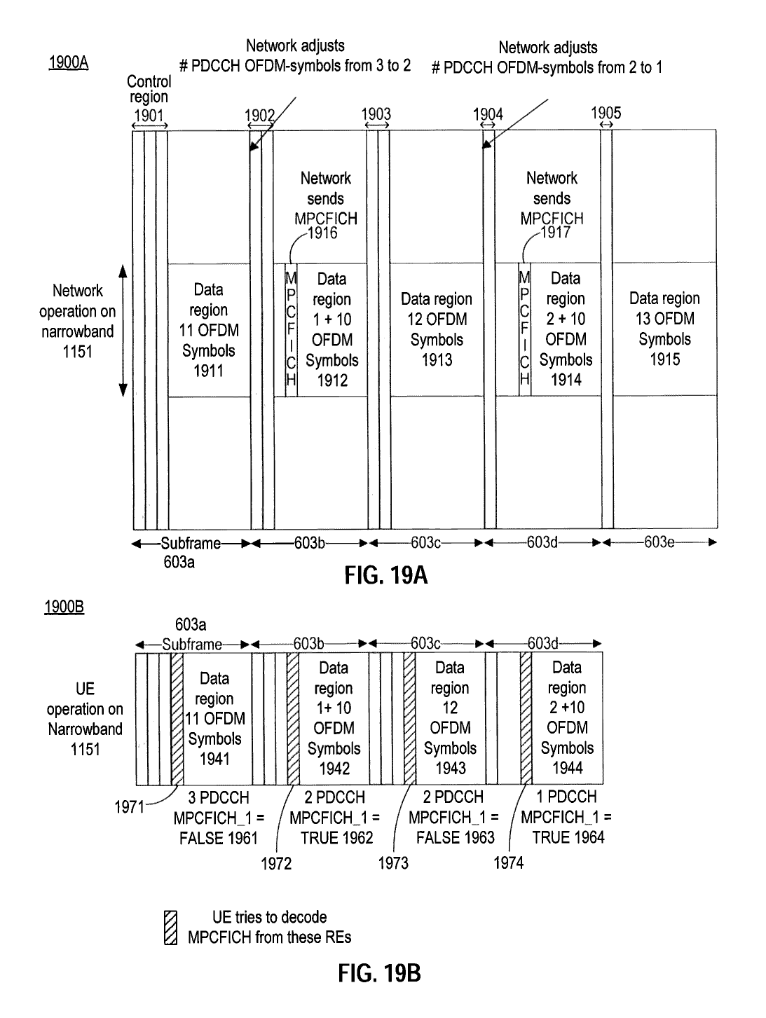

FIGS. 19A and 19B illustrate an exemplary operation of the network and MTC UE, respectively, on narrowband when the network signals MPCFICH at a constant position when size of control region decreases. In the example illustrated in FIGS. 19A and 19B, the network always transmits MPCFICH, when needed, on the fourth OFDM symbol in a subframe.

FIG. 19A shows that each subframe (e.g., 603a-603e) comprises a control region (e.g., 1901-1905) and a data region (e.g., 1911-1915). In this example, in a first subframe 603a, the size of the control region 1901 is 3 PDCCH OFDM symbols, and the size of data region 1911 is 11 OFDM symbols.

Assuming the number of PDCCH OFDM symbols is 3 in both subframe 603a and the subframe preceding 603a, the network does not send MPCFICH in subframe 603a because the number has not changed. Referring to FIG. 19B, the MTC UE attempts to decode MPCFICH from the fourth OFDM symbol 1971, because MPCFICH, if transmitted, would be transmitted on that OFDM symbol. But because no MPCFICH was transmitted in that OFDM symbol, the MTC UE fails to decode MPCFICH (MPCFICH_1=FALSE at 1961).

In subframe 603d, the network decreases the number of PDCCH OFDM symbols to 2 and sends MPCFICH 1916 in the fourth OFDM symbol in the narrowband for the MTC UE. The size of data region 1912 becomes 1+10 OFDM symbols. Referring to FIG. 19B, the MTC UE tries again to decode MPCFICH from the fourth OFDM symbols 1972 and succeeds (MPCFICH_1=TRUE at 1962). From the decoded MPCFICH, the MTC UE learns the size of control region 1902 to be 2 OFDM symbols and the size of data region 1912/1942 to be 1+10 OFDM symbols in subframe 603b, because one OFDM symbol is used for MPCFICH.

In the third subframe 603c, the network does not send MPCFICH, because the control region size does not change. The size of data region 1913 is 12 OFDM symbols. Referring to FIG. 19B, the MTC UE again tries to decode MPCFICH from the fourth OFDM symbol 1973 and fails (MPCFICH_1=FALSE at 1963).

In the fourth subframe 603d, the network decreases the number of PDCCH OFDM symbols to 1 and sends MPCFICH 1917 in the fourth OFDM symbol in the narrowband for the MTC UE. The size of data region 1914 becomes 2+10 OFDM symbols. Referring to FIG. 19B, the MTC UE tries again to decode MPCFICH from the fourth OFDM symbol 1974 and succeeds (MPCFICH_1=TRUE at 1964). From the decoded MPCFICH, the MTC UE learns the size of control region 1904 to be one OFDM symbol and the size of data region 1914/1944 to be 2+10 OFDM symbols, because one OFDM symbol is used for MPCFICH.

In the fifth subframe 603e, network does not send MPCFICH since the size of control region does not change. The size of data region 1915 remains 13 OFDM symbols.

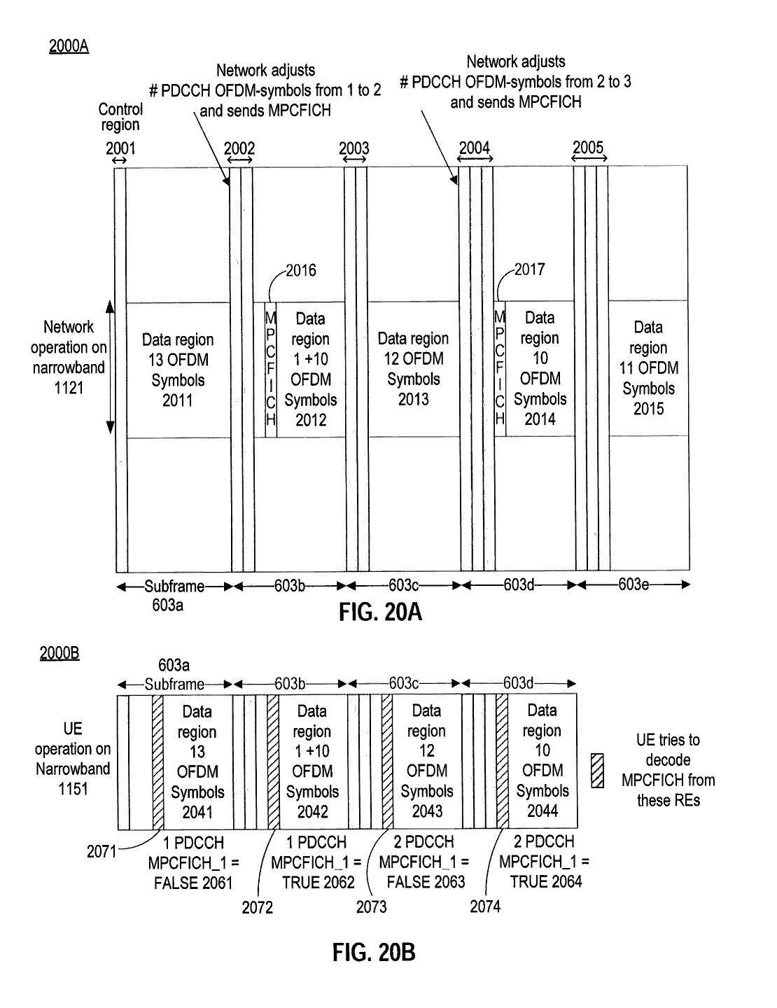

FIGS. 20A and 20B illustrate an exemplary operation of the network and MTC UE, respectively, on narrowband when the network signals MPCFICH at a constant position when size of control region increases. In the example illustrated in FIGS. 20A and 20B, the network always transmits MPCFICH, when needed, on the fourth OFDM symbol in a subframe.

FIG. 20A shows that each subframe (e.g., 603a-603e) comprises a control region (e.g., 2001-2005) and a data region (e.g., 2011-2015). In this example, in a first subframe 603a, the size of the control region 2001 is 1 PDCCH OFDM symbol, and the size of data region 2011 is 13 OFDM symbols.

Assuming the number of PDCCH OFDM symbols is 1 in both subframe 603a and the subframe preceding 603a, the network does not send MPCFICH in subframe 603a because the number has not changed. Referring to FIG. 20B, the MTC UE attempts to decode MPCFICH from the fourth OFDM symbol 2071, because MPCFICH, if transmitted, would be transmitted on that OFDM symbol. But because no MPCFICH was transmitted in that OFDM symbol, the MTC UE fails to decode MPCFICH (MPCFICH_1=FALSE at 2061).

In subframe 603b, the network increases the number of PDCCH OFDM symbols to 2 and sends MPCFICH 2016 in the fourth OFDM symbol in the narrowband for the MTC UE. The size of data region 2012 becomes 1+10 OFDM symbols. Referring to FIG. 20B, the MTC UE tries again to decode MPCFICH from the fourth OFDM symbols 2072 and succeeds (MPCFICH_1=TRUE at 2062). From the decoded MPCFICH, the MTC UE learns the size of control region 2002 to be 2 OFDM symbols and the size of data region 2012/2042 to be 1+10 OFDM symbols in subframe 603b, because one OFDM symbol is used for MPCFICH.

In the third subframe 603c, the network does not send MPCFICH, since the size of control region does not change. The size of data region 2013 becomes 12 OFDM symbols. Referring to FIG. 20B, the MTC UE again tries to decode MPCFICH from the fourth OFDM symbol 2073 and fails (MPCFICH_1=FALSE at 2063).

In the fourth subframe 603d, the network increases the number of PDCCH OFDM symbols to 3 in subframe 603d and sends MPCFICH 2017 in the fourth OFDM symbol in the narrowband for the MTC UE. The size of data region 2014 becomes 10 OFDM symbols. Referring to FIG. 20B, the MTC UE tries again to decode MPCFICH from the fourth OFDM symbol 2074 and succeeds (MPCFICH_1=TRUE at 2064). From the decoded MPCFICH, the MTC UE learns the size of control region 2004 to be 3 OFDM symbol and the size of data region 2014/2044 to be 10 OFDM symbols in subframe 603d, because one OFDM symbol is used for MPCFICH.

In the fifth subframe 603e, the network does not send MPCFICH because the size of control region does not change. The size of data region 2015 remains 11 OFDM symbols.

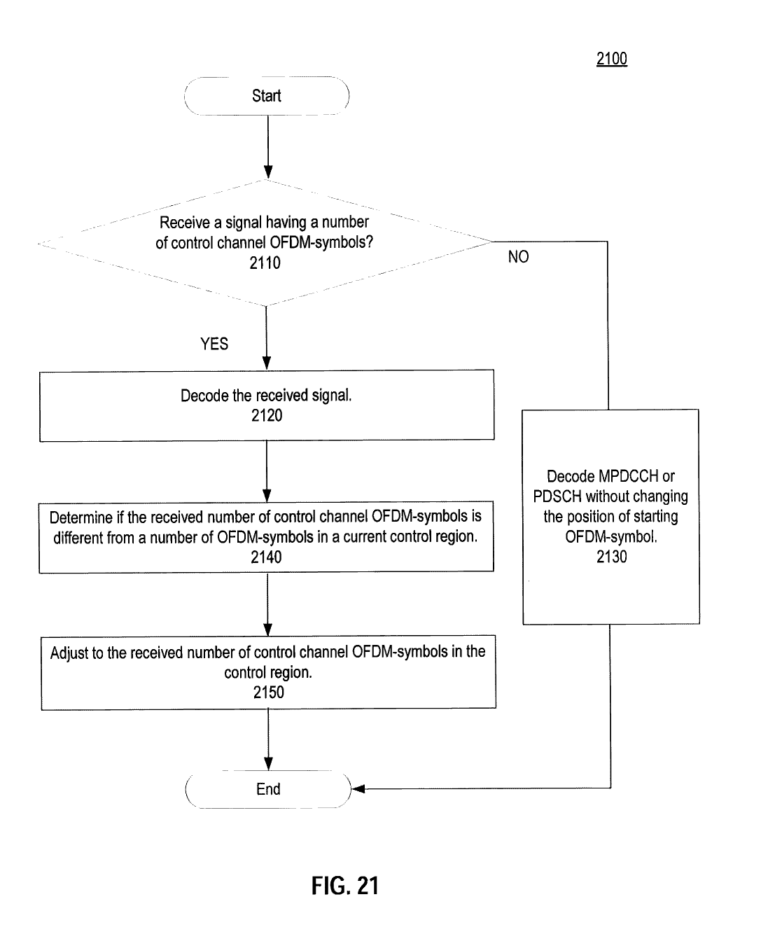

FIG. 21 illustrates an exemplary method of decoding a control channel signal according to an illustrative embodiment of the present disclosure. Method 2100 may be executed by one or more devices included in system apparatus or UE apparatus, such as a control channel decoder, or other processing device. Method 2100 may include signaling over a plurality of subframes 603 (e.g., 603a, . . . , 603z), each subframe having a control region and a data region.

Method 2100 may include determining if a signal contains information about the number of control channel OFDM symbols is received from a network at step 2110. If the MTC UE determines that a signal containing the number of control channel OFDM symbols has been received, it may decode the received signal at step 2120. In one embodiment, the information about the number of the control channel OFDM symbols is received in MPCFICH. Otherwise, at step 2130, the MTC UE assumes that the number of OFDM symbols in the control region has not changed and decodes MPDCCH and/or PDSCH without changing the position of a starting OFDM symbol.

If the MTC UE successfully decodes the received signal at step 2120 and determines, at step 2140, that the number of control channel OFDM symbols in the control region has changed in the current subframe or will change in a subsequent subframe, the MTC UE adjusts, at step 2150, the starting OFDM symbol for MPDCCH and PDSCH accordingly.

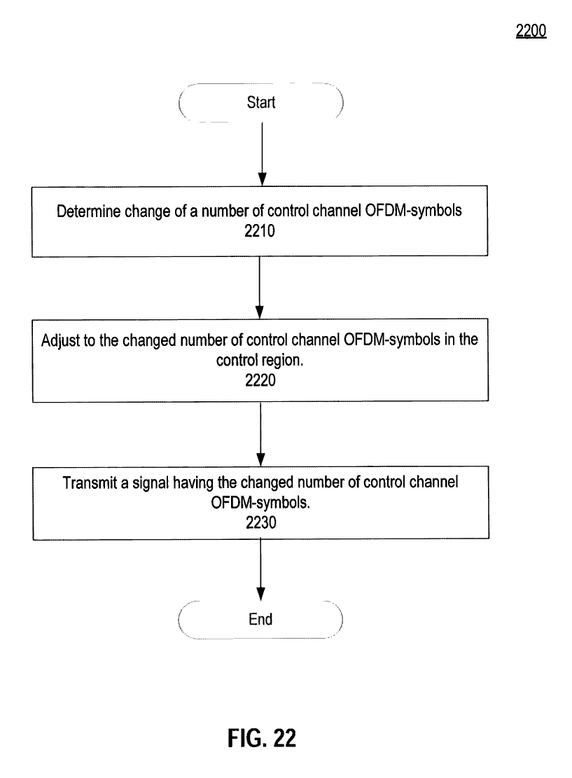

FIG. 22 illustrates an exemplary method of signaling a change in the number of control channel OFDM symbols according to an illustrative embodiment of the present disclosure. Method 2200 may be executed by one or more devices included in system apparatus, base station apparatus, or eNodeB apparatus. Method 2100 may signaling over a plurality of subframes 603 (e.g., 603a, . . . , 603z), each subframe having a control region and a data region. In one aspect, method 2200 may be performed by a communications network to signal the change in the number of control channel OFDM symbols to an MTC UE.

Method 2200 may include determining change of a number of control channel OFDM symbols for a subframe at step 2210. Method 2200 may also include adjusting to the changed number of control channel OFDM symbols in the control region at step 2220. Method 2200 may further include transmitting a signal having the changed number of control channel OFDM symbols to user equipment at step 2230. In one embodiment, the information about the number of the control channel OFDM symbols is received in MPCFICH. In another aspect, not illustrated as part of method 2200 in FIG. 22, the method consistent with the present disclosure may include signaling in a subframe a change in the number of control channel OFDM symbol for a subsequent subframe and then adjusting transmissions in the next subframe according to the change.

While illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed routines may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. An apparatus for use in an Orthogonal Frequency Division Multiplexing (OFDM) wireless system, wherein the system supports transmissions of OFDM signals over a frequency band and includes a network component that communicates with the apparatus, the apparatus comprising:
a receiver configured to receive signals in a narrowband within the frequency band, the narrowband having a narrower bandwidth than the frequency band; and
a decoder configured to decode an indicator channel within the narrowband to determine a starting OFDM symbol for control and/or data information intended for the apparatus.

2. The apparatus of claim 1, further comprising a processor configured to determine whether the received signals include the size of a control region.

3. The apparatus of claim 2, wherein the processor is configured to adjust the position for the starting OFDM symbol based on the determination and to decode control information and/or data starting from the starting OFDM symbol.

4. The apparatus of claim 2, wherein the processor is further configured to determine a change in a size of a data region based on the indicator channel.

5. The apparatus of claim 1, wherein the decoder is configured to decode the indicator channel one or more times in a current control region or data region in a current subframe.

6. The apparatus of claim 1, wherein the decoder is configured to decode the indicator channel over two consecutive OFDM symbols.

7. The apparatus of claim 1, wherein the decoder is configured to decode the indicator channel at a predetermined position in a current control region or data region in a current subframe.

8. The apparatus of claim 1, wherein the receiver is configured to receive a signal indicating a specific position of OFDM symbol to decode the indicator channel.

9. The apparatus of claim 1, wherein the indicator channel is Machine Type Communication Physical Control Format Indicator CHannel (MPCFICH).

10. A method of determining a starting Orthogonal Frequency Division Multiplexing (OFDM) symbol following control channel OFDM symbols transmitted over a frequency band, the method comprising:
receiving signals in a narrowband within the frequency band, the narrowband having a narrower bandwidth than the frequency band; and
decoding an indicator channel within the narrowband to determine a starting OFDM symbol for control and/or data information.

11. The method of claim 10, wherein the control channel OFDM symbols are transmitted within a control region, the method further comprising determining whether the received signals include the size of the control region.

12. The method of claim 10, further comprising adjusting the position for the starting OFDM symbol based on the determination and to decode control information and/or data starting from the starting OFDM symbol.

13. The method of claim 10, further comprising determining a change in a size of a data region based on the indicator channel.

14. The method of claim 10, further comprising decoding the indicator channel one or more times in a current control region or data region in a current subframe.

15. The method of claim 10, further comprising decoding the indicator channel over two consecutive OFDM symbols.

16. The method of claim 10, further comprising decoding the indicator channel at a predetermined position in a current control region or data region in a current subframe.

17. The method of claim 10, further comprising receiving a signal indicating a specific position of OFDM symbol and decoding the indicator channel at the specific position.

18. The method of claim 10, wherein the indicator channel is Machine Type Communication Physical Control Format Indicator CHannel (MPCFICH).

19. A non-transitory computer readable storage medium that stores a set of instructions executable by a processor to cause an apparatus to determine a starting Orthogonal Frequency Division Multiplexing (OFDM) symbol following control channel OFDM symbols transmitted over a frequency band, the method comprising:
receiving signals in a narrowband within the frequency band, the narrowband having a narrower bandwidth that the frequency band; and
decoding an indicator channel within the narrowband to determine a starting OFDM symbol for control and/or data information.

20. An apparatus of signaling a starting Orthogonal Frequency Division Multiplexing (OFDM) symbol, comprising:
a processor configured to determine a change in a number of control channel OFDM symbols over a frequency band; and
a transmitter configured to transmit an indicator channel over a narrowband within the frequency band to indicate a starting OFDM symbol, the narrowband having a narrower bandwidth than the frequency band.

21. The apparatus of claim 20, wherein the indicator channel is Machine Type Communication Physical Control Format Indicator CHannel (MPCFICH).

22. The apparatus of claim 20, wherein the processor is further configured to determine a change in a size of a data region based on the change in the number of control channel OFDM symbols.

23. The apparatus of claim 20, wherein the transmitter is further configured to transmit a signal indicating a specific position of OFDM symbol to decode the indicator channel.

24. The apparatus of claim 20, wherein the transmitter configured to transmit the indicator channel comprises transmitting the indicator channel in a data region of the narrowband.

25. The apparatus of claim 20, wherein the transmitter is configured to transmit the indicator channel comprises transmitting the indicator channel over one OFDM symbol or two consecutive OFDM symbols.

26. An method of signaling a starting Orthogonal Frequency Division Multiplexing (OFDM) symbol, comprising:
determining a change in a number of control channel OFDM symbols over a frequency band; and
transmitting an indicator channel over a narrowband within a frequency band to indicate a starting OFDM symbol, the narrowband having a narrower bandwidth than the frequency band.

27. The method of claim 26, wherein the indicator channel is Machine Type Communication Physical Control Format Indicator CHannel (MPCFICH).

28. The method of claim 26, further comprising determining change in a size of a data region based on the change in the number of control channel OFDM symbols.

29. The method of claim 26, further comprising transmitting a signal indicating a specific position of OFDM symbol to decode the indicator channel.

30. The method of claim 26, wherein the transmitting the indicator channel comprises transmitting the indicator channel in a data region of the narrowband.

31. The method of claim 26, wherein the transmitting the indicator channel comprises transmitting the indicator channel over one OFDM symbol or two consecutive OFDM symbols.
